(19) United States
(12) Patent Application Publication
(10) Pub. No.: US 2026/0228648 A1
(43) Pub. Date: Aug. 6, 2026

(54) METHODS AND SYSTEMS FOR PASSIVE RFID-BASED ACTIVITY DETERMINATION

(71) Applicant: THE UNIVERSITY COURT OF THE UNIVERSITY OF GLASGOW, Glasgow Strathclyde (GB)

(72) Inventors: Qammer Hussain ABBASI, Glasgow (GB); Ahsen TAHIR, Glasgow (GB); Shuja ANSARI, Glasgow (GB); Hasan ABBAS, Glasgow (GB); Muhammad Ali IMRAN, Glasgow (GB); Muhammad Zakir KHAN, Glasgow (GB)

(21) Appl. No.: 19/150,159

(22) PCT Filed: Jan. 22, 2024
(86) PCT No.: PCT/EP2024/051444

§ 371 Date: Jul. 22, 2025

(30) Foreign Application Priority Data
Jan. 23, 2023 (GB) 2300942.6
Nov. 9, 2023 (GB) 2317204.2

(51) Int. Cl. G06Q 10/02; G06N 3/047; H04W 4/33; H04W 4/38; H04W 4/80

(52) U.S. Cl. CPC G06Q 10/028; G06N 3/047; H04W 4/33; H04W 4/38; H04W 4/80

(57) ABSTRACT

There is provided a method and a system for determining an activity being performed by a person and/or monitoring occupancy in an environment. The environment comprises a plurality of passive RFID tags. The method comprises: receiving, over a sample period, in response to an interrogation signal, one or more response signals from one or more of the passive RFID tags; determining, for each passive RFID tag, a normalised count value based on a number of response signals received from said passive RFID tag over the sample period; and using a machine learning algorithm to determine the activity being performed in the environment and/or monitor occupancy of the environment. The machine learning algorithm is configured to take the normalised count values as inputs, and determine, based on the normalised count values, the activity or occupancy during the sample period.

### FIELD OF THE INVENTION

The present invention relates to methods and systems for determining an activity being performed in an environment. In one aspect, the present invention relates to methods and systems for determining the levels of occupancy in a seating environment and particularly, although not exclusively, to methods and systems for determining the levels of occupancy in, e.g., an office-based environment; in some cases implementing an Internet of Things architecture.

### BACKGROUND

Ambient Assisted Living (AAL) solutions seek to support the elderly and disabled to live independently by monitoring their activities at home and providing assistance based on the determined activities.

Conventional approaches for activity monitoring include the deployment of bespoke and expensive hardware such as extensive video surveillance cameras that collect large volumes of complex data and require extensive processing. Alternatively, people can be hired to monitor footage from the video surveillance cameras. Therefore, the costs associated with activity monitoring using these systems can rapidly become prohibitive. Additionally, activity monitoring using surveillance cameras leads to privacy concerns, particularly if they are used for activity monitoring in a person's private home.

Inefficient use of space is a challenge faced in many sectors, and particularly in the field of estate management. Many centres of activity, for example, educational, business and/or cultural centres face notorious challenges in space management and particularly, in managing occupancy levels of these centres.

Conventional approaches for occupancy monitoring include the deployment of bespoke and expensive hardware such as temperature sensors and/or extensive video surveillance cameras that collect large volumes of complex data and require extensive processing. In high-occupancy environments (e.g., environments where the occupancy can exceed 100 people) such as offices, lecture theatres, and even public transport settings, the costs associated with occupancy monitoring using these systems can rapidly become prohibitive.

Historically, passive RFID tags have been used for tracking the entry and exit of individuals or objects through gateways such as the entrances of buildings, shops, offices, and the like. However, passive RFID tags' received signal strength indication (RSSI) and phase fluctuations are random, limiting their use in providing detailed information about a person's activities in an environment at a given point in time. The use of such entry/exit information is also of limited use in providing detailed information on occupancy levels of an environment at a given point in time. Moreover, the use of passive RFID tags is unfeasible or unviable in certain circumstances. For example, if the potential occupants of a large space form a large population it may not be appropriate to assign each member of that population a dedicated RFID tag. Where tags are associated with individuals, there may also be concerns relating to privacy.

There is therefore a need to provide a low-cost solution to activity monitoring activity in an environment, and in particular to occupancy monitoring in high-occupancy environments. The inventors have devised the present invention in light of these considerations.

### SUMMARY OF THE INVENTION

### Occupancy Monitoring

In a general sense, the present invention provides methods and systems that are able to determine the level of occupancy in a seating environment based on response signals received from passive RFID tags attached to seats in the seating environment. The use of passive RFID tags would not normally be considered suitable for this purpose because of wide variations in signal strength and phase of the signals emitted by passive RFIDs are almost completely random. The invention addresses and overcomes this technical limitation by demonstrating that it is in fact possible to determine whether or not a seat is occupied based on variations in the number of passive RFID tag response signals received over a predetermined time period. In other words, occupancy determination is made possible, according to the present invention, based on a count of the number of received passive RFID tag response signals. Such a method and system offers significant advantages because passive RFID tags are inexpensive and readily available, making them particularly suitable for use in high-occupancy environments.

The invention is set out in the appended set of claims.

In a first aspect, there is provided a method for determining occupancy in a seating environment, the seating environment comprising a plurality of seats, each seat having a group of passive RFID tags attached thereto. The method comprises: receiving, over a predetermined time period, in response to an interrogation signal, one or more response signals from one or more of the passive RFID tags in the seating environment; determining, for each passive RFID tag in the seating environment, a normalised count value based on the number of response signals received from said passive RFID tag over the predetermined time period; and determining an occupancy state for each seat in the seating environment based on the determined normalised count values.

In this way, and particularly by basing the determination of occupancy state on the normalised count values for each of the passive RFID tags, it is possible to discriminate between the small differences in the number of response signals received from said passive RFID tags arising from differences in the occupancy state of the seats in the seating environment. This consequently facilitates a determination of occupancy in a seating environment using passive RFID tags, components that are both inexpensive and readily available in large quantities. Accordingly, the methods and systems disclosed herein may be particularly suitable for use in high-occupancy environments where the costs and complexity associated with standard sensor types such as thermal sensors and surveillance cameras may be cost prohibitive.

The methods disclosed herein may be applied to determining occupancy levels across a broad range of seating environments. For example, the seating environment may be in a commercial setting such as an office (e.g., an open plan office), an educational setting such as a lecture theatre, a classroom, or similar, or a public transport setting such as a train, bus, coach, or similar. The methods and systems disclosed herein may be equally applicable in other seating environments in addition to those listed here.

In some examples, the method for determining occupancy may include continuous or substantially continuous monitoring of the occupancy of the seating environment. For example, the method may include continuously monitoring the number of occupied seats within the seating environment (also referred to as the occupancy level) and report the occupancy level to users in real-time or near real-time.

In some examples, the method for determining occupancy may be carried out on request of a user. For example, a user may be entering, or about to enter, the seating environment and want to know if there is still space (based on the occupancy state of the seating environment) for them to sit down. In such a case, the user may interact with an appropriate user interface and cause the methods disclosed herein to be implemented to determine the occupancy state of the seating environment. This may include, in some examples, informing the user via a graphical user interface or similar, whether there are any remaining seats available to be occupied by the user and/or which seats in the seating environment are available to be occupied by the user. In these examples, carrying out the methods disclosed herein on request of the user may be a more efficient use of resources than continuous or substantially continuous monitoring and so may be preferable in settings where the need to determine occupancy may be relatively infrequent.

In order to implement the methods disclosed herein, the predetermined time period over which responses to the interrogation signal are received from one or more of the passive RFID tags may be a time period long enough to receive a sufficient number of response signals to be able to discriminate between different occupancy states of seats in the seating environment based on the normalised count values determined based on the received response signals. In some examples, therefore, the predetermined time period may be 5 seconds or more, 10 seconds or more, 15 seconds or more, 20 seconds or more, or 30 seconds or more.

In some examples, in order to implement the methods disclosed herein, the predetermined time period over which responses to the interrogation signal are received from one or more of the passive RFID tags may be a time period short enough that it is unlikely that the occupancy state of a seat in the seating environment has changed (e.g., a person has started or stopped sitting in a seat) over that time period. In some examples, therefore, the predetermined time period may be 60 seconds or less, 45 seconds or less, 30 seconds or less, or 20 seconds or less.

In some examples, both of these considerations may be taken into consideration and the predetermined time period may be determined as a balance point between collecting a sufficient number of response signals, and reducing the risk that an occupancy state of a seat in the seating environment changes during the predetermined time period. In some examples, therefore, the predetermined time period may be between 5 and 20 seconds, 5 and 30 seconds, 5 and 45 seconds, 5 and 60 seconds, 10 and 20 seconds, 10 and 30 seconds, 10 and 45 seconds, 10 and 60 seconds, 15 and 20 seconds, 15 and 30 seconds, 15 and 45 seconds, 15 and 60 seconds, 20 and 30 seconds, 20 and 45 seconds, 20 and 60 seconds, 30 and 45 seconds, or 30 and 60 seconds.

In a particular example, the predetermined time period may be 10 seconds, 15 seconds, 20 seconds, or 30 seconds.

In some examples, the one or more response signals may be received by one or more RFID readers installed in the seating environment. RFID readers may be particularly straightforward and efficiently installable, both in terms of technical and cost considerations. The one or more RFID readers may, for example, be installed on a ceiling of the seating environment to ensure response signals from as wide a coverage area as possible can be received at each RFID reader.

The number of RFID readers deployed in the seating environment may depend, for example, on the size and/or geometry of the seating environment. For example, it may be preferable to position each of the one or more RFID readers at equidistant intervals along the ceiling of the seating environment. For example the interval may be 10 metres or more, 15 metres or more, 20 metres or more, 50 metres or more, or 100 metres or more.

Additionally, in seating environments where walls and other boundaries/obstacles (e.g., pillars) comprise metallic (or otherwise electrically conductive) elements, it may be advantageous to position the RFID readers such that there is always at least one direct line of communication between each passive RFID tag and a RFID reader that does not pass through such a wall or boundary/obstacle regardless of the positioning of the seat to which the passive RFID tag is attached within the seating environment. This is because any metallic (or otherwise electrically conductive) elements may block radio frequency signals transmitted to and from the passive RFID tags, thereby reducing the accuracy of the methods and systems disclosed herein.

In some embodiments, the seating environment may further comprise one or more RFID antennae configured to broadcast the interrogation signal throughout the seating environment.

RFID antennae may be particularly straightforward and efficiently installable, both in terms of technical and cost considerations. The one or more RFID antennae may, for example, be installed on a ceiling of the seating environment to ensure as wide a coverage area as possible for each RFID antenna.

The number of RFID antenna deployed in the seating environment may depend, for example, on the size and/or geometry of the seating environment. For example, it may be preferable to position each of the one or more RFID antennae at equidistant intervals along the ceiling of the seating environment. For example, the interval may be 10 metres or more, 15 metres or more, 20 metres or more, 50 metres or more, or 100 metres or more.

Additionally, in seating environments where walls and other boundaries/obstacles (e.g., pillars) comprise metallic (or otherwise electrically conductive) elements, it may be advantageous to position the one or more RFID antennae such that there is always at least one direct line of communication between each passive RFID tag and a RFID antenna that does not pass through such a wall or boundary/obstacle regardless of the positioning of the seat to which the passive RFID tag is attached within the seating environment. This is because any metallic (or otherwise electrically conductive) elements may block the radio frequency interrogation signal(s) broadcast by the one or more RFID antennae, thereby reducing the accuracy of the methods and systems disclosed herein.

In some examples, the seating environment may be divided into different sections, wherein each section includes a single dedicated RFID antenna and/or a single dedicated RFID reader. In this way, it may be possible to provide more granular determinations of the occupancy state of individual sections of the seating environment.

Further, in examples, where RFID readers are also deployed in the seating environment, it may be preferable to deploy a RFID reader in proximity to an RFID antenna, i.e., the RFID readers and RFID antennae may be deployed in pairs. In such examples, the RFID reader(s) may only be activated if and when the corresponding RFID antenna(e) are actively broadcasting an interrogation signal.

In some examples, the one or more RFID antennae may be configured to continuously broadcast the interrogation signal(s). This continuous broadcast may be time-limited in some examples by a user or administrator of the methods and systems disclosed herein. For example, in a commercial setting such as an office, the one or more RFID antennae may be configured to broadcast interrogation signals only during operating business hours of the commercial setting. Similarly, in other settings, the one or more RFID antennae may be configured to broadcast interrogation signals continuously during the operating hours (e.g., standard opening hours) of the setting in which the seating environment is located.

In some embodiments, the occupancy state for each seat may be determined based on the determined normalised count values for the group of passive RFID tags attached to that seat.

In this way, only passive RFID tags attached to a particular seat may be used in the determination of that occupancy state of that seat within the seating environment. In this way, in addition to determining an overall occupancy state for the seating environment (e.g., the number of occupied seats within the seating environment), it may be possible to determine the occupancy state for each individual seat within the seating environment and report these individual occupancy states to a user.

In some embodiments, the method may further comprise: receiving, over a predetermined control time period, in response to an interrogation signal, one or more response signals from each passive RFID tag, wherein said passive RFID tag is attached to a seat that is unoccupied for the duration of the control time period; determining, for each passive RFID tag, a control-count value, the control-count value being an aggregate of the number of response signals received from said passive RFID tag over the control time period.

In some embodiments, the determining, for each passive RFID tag, a normalised count value may comprise: comparing the number of response signals received from said passive RFID tag over the predetermined time period with the control-count value for said passive RFID tag.

In some examples, the control time period may be equal in length to the predetermined time period. This may make the determination of the normalised count values more reliable because each normalised count value is determined by comparing the control-count value with a number of response signals received over an equivalent period of time.

In some examples, each normalised count value may be determined by determining a ratio of the number of response signals received from the corresponding passive RFID tag over the predetermined time period and the control-count value for said passive RFID tag.

By determining each of the normalised count values in this way, it may be possible to discriminate, based on the differing normalised count values, between different occupancy states of the seats within the seating environment.

In some embodiments, the method may further comprise: storing, for each passive RFID tag, the determined control-count value.

The control-count value for each passive RFID tag could be determined, for example, on initialisation or installation of the passive RFID tag on a seat in the seating environment so that it is possible to determine normalised count values based on the corresponding control-count value as soon as the installation of the RFID tags on the corresponding seat has been completed.

In some examples, the control-count value could be redetermined periodically, for example to account for change over time (or degradation) in the passive RFID tag's performance. For example, the control-count value may be redetermined daily, weekly, fortnightly, monthly, bi-monthly, quarterly, bi-annually, annually, or biennially, depending on the rate of change of performance for the passive RFID tag.

In some examples, each control-count value could be stored with corresponding metadata. The metadata could, for example, include information indicative of how much time has passed since the control-count value was determined. The system may include logic that causes the control count to be re-determined if the metadata indicates that the amount of time since the control-count value was last determined exceeds a predetermined threshold.

In some examples, the stored control-count value could be tagged with an ID corresponding to the seat to which the corresponding passive RFID tag is attached. If users of the method and system disclosed herein report errors in the occupancy state determination for that seat, then the control-count value may be redetermined to improve the accuracy of the eventual determinations of the occupancy state for that seat. For example, the control-count value may be re-determined if the error-rate in occupancy determination exceeds a predefined threshold.

In some embodiments, the determining an occupancy state for each seat may be carried out by a central server remote from the seating environment.

By carrying out the necessary processing steps to determine the occupancy state(s) in the seating environment at a remote central server, the processing requirements for the methods disclosed herein can be removed from the seating environment. In this way, it may be possible to concentrate all of the processing requirements at a single central server that may be configured to determine and/or monitor occupancy states across multiple independent or related seating environments.

In some embodiments, the method may further comprise: communicating, by the central server, with the one or more RFID antennae over a 5G Internet of Things network.

In this way, the high transfer speeds achievable with 5G networks can be leveraged in an interconnected Internet of Things network to reduce latency and improve processing speed, thereby allowing for real-time or near real-time determinations and/or monitoring of the occupancy state(s) within the seating environment.

In some embodiments, the central server may be configured to communicate with users of the seating environment via an application-programming interface.

For example, in instances where a user of the methods and systems disclosed herein, can request an occupancy state determination on demand (e.g., to determine whether there are any seats available in the seating environment for them to occupy, and which seats are available/unavailable to be occupied), this may be done via an application-programming interface (API), that may be accessible, for example, through a web-based app.

In cases where the central server is adapted to determine occupancy states across multiple seating environments, this may enable a user to determine what seats are available to be occupied across any one or more (including all) of these seating environments on request. This means that in a wider setting with multiple seating environments, the user could find an available seat so that they do not waste a journey to a fully occupied seating environment and instead travel to a seating environment with occupancy capacity (e.g., the user could, by implementing the methods disclosed herein, identify which library/libraries on a university campus have seating occupancy).

In some embodiments, determining the occupancy state for each seat may comprise: determining a type of occupancy for each seat determined to be occupied.

The occupancy types could include, for example, whether a seat is occupied by a person or by an inanimate object (e.g., a person's bag or coat). In this case, it may be possible to indicate to a user of the methods and systems disclosed herein that a seat is not actually occupied because it is occupied by an inanimate object as opposed to a person. In such scenarios, that group of RFID tags on each seat may comprise three or more passive RFID tags, including one on the seat and two or more at different positions at the back of the seat.

In some examples, the occupancy types could include the posture in which a person is occupying a seat. For example, the occupancy types could include: “leaning forward”, “leaning back”, “slouching”, “sitting upright”, or other occupancy types. This information could be useful, for example, in a commercial setting where it may be advantageous to determine if people are using seats in the office in a way that is suitable for long-term occupancy (e.g., if the people using the seats are sitting in those seats in a way complying with relevant health & safety guidelines) so that the users of the seats can be informed of their posture and encouraged to adopt a more suitable posture, i.e., “sitting upright”.

In some embodiments, the determining an occupancy state for each seat may comprise applying a machine learning algorithm configured to take the determined normalised count values as inputs, and determine, based on the determined normalised count values, an occupancy state for each seat in the seating environment.

A machine learning algorithm may be able to discriminate between otherwise unrecognisable variations in the normalised count values for a given passive RFID tag. In particular, an appropriately trained machine learning algorithm may be able to identify variations in the normalised count values that are indicative of differences in occupancy state, where those variations would not be apparent based on non-machine learning analysis techniques or, indeed, analysis by the naked eye.

In some embodiments, the machine learning algorithm may be an ensemble algorithm, optionally comprising one or more of: a support vector machine; a ridge classifier; a stochastic gradient descent algorithm; and/or a multi-layer perceptron.

In some examples, an ensemble machine learning algorithm may be able to achieve a higher accuracy in occupancy state determination than would otherwise be achievable.

For example, a particularly accurate and effective ensemble algorithm may comprise a first element configured to operate as a single vector machine, a second element configured to operate as a ridge classifier, a third element configured to operate as a stochastic gradient descent algorithm, a fourth element configured to operate as a multilayer-perceptron and/or optionally a fifth element configured to operate as another multilayer-perceptron that is adapted to function as a stacked classifier on top of the other elements of the ensemble algorithm. The precise nature of each of the components of the ensemble algorithm may be selected and adapted by the user of the methods and systems disclosed herein in order to achieve the highest possible accuracy. Furthermore, deep learning algorithms such as LSTM etc. can also be utilised in machine learning and can capture variations in normalised counts overtime.

In some embodiments, each group of passive RFID tags may comprise at least three passive RFID tags spaced apart on the seat.

In some examples, three passive RFID tags per seat may be a preferable number, wherein each seat may have a first passive RFID tag attached to a base section of the seat (corresponding to the section of the seat that the seated person would sit upon), a lower back section of the seat (corresponding to where the lower back of a seated person would contact the seat in use), and an upper back/head section of the seat (corresponding to where the upper back, neck, or head of a seated person would contact the seat in use). Three passive RFID tags spaced apart on the seat may provide sufficient data to be able to determine the occupancy state of the seat based on the three normalised count values of the three attached passive RFID tags.

In other examples, an alternative number of passive RFID tags may be attached to each seat, for example, 2 or more, 4 or more, or 5 or more. In some examples, the methods and systems described herein may be successfully implemented even with just one passive RFID tag attached to each seat.

In a further aspect, there is provided a method of training a machine learning algorithm to determine an occupancy state of a seat in a seating environment. The method comprises: providing an untrained machine learning algorithm configured to predict an occupancy state of a seat in a seating environment based on received normalised count values associated with passive RFID tags attached to the seat, wherein each normalised count value is based on a number of response signals received from a respective passive RFID tag over a predetermined time period in response to an interrogation signal; receiving training data, the training data comprising a plurality of labelled sets of normalised count values associated with a passive RFID tag, wherein each of the sets of normalised count values is labelled with a label indicative of the occupancy state of the seat during the predetermined time period; training the machine learning algorithm by: applying the machine learning algorithm to the training data to predict an occupancy state of the seat for each labelled set; comparing, for each labelled set, the prediction of the machine learning algorithm with the label; and if the machine learning algorithm predicted a different occupancy state of the seat to the state indicated by the label: adapting the machine learning algorithm based on the received plurality of labelled normalised count values to improve the accuracy of the prediction; and repeating the training of the machine learning algorithm until the accuracy of the machine learning algorithm exceeds a predetermined threshold.

In this way, the machine learning algorithm introduced above with respect to some embodiments of the first aspect can be particularly well trained and adapted to determining the occupancy of a state based on the specific RFID tags attached thereto. The machine learning algorithm may be retrained at regular intervals to account for changes over time (or degradation) in the performance of the passive RFID tags. In this way, the machine learning algorithm can be used in a way that maintains consistently accurate determinations of the occupancy state(s) of the seating environment.

In some embodiments each normalised count value may be based on a comparison between number of response signals received from the respective passive RFID tag over the predetermined time period, and a control-count value, the control-count value being an aggregate of a number of response signals received from the same passive RFID tag over a control time period in response to an interrogation signal, wherein the passive RFID tag may be attached to a seat that is unoccupied for the duration of the control time period.

As discussed above, in some examples, the control time period may be equal in length to the predetermined time period. This may make the determination of the normalised count values more reliable because each normalised count value is determined by comparing the control-count value with a number of response signals received over an equivalent period of time.

In some examples, each normalised count value may be determined by determining a ratio of the number of response signals received from the corresponding passive RFID tag over the predetermined time period and the control-count value for said passive RFID tag.

By determining each of the normalised count values in this way, it may be possible to discriminate, based on the differing normalised count values, between different occupancy states of the seats within the seating environment.

The determined control-count value for each passive RFID tag may, in some examples be stored. The control-count value for each passive RFID tag could be determined, for example, on initialisation or installation of the passive RFID tag on a seat in the seating environment so that it is possible to determine normalised count values based on the corresponding control-count value as soon as the installation of the RFID tags on the corresponding seat has been completed.

In some examples, the control-count value could be redetermined periodically, for example to account for change over time (or degradation) in the passive RFID tag's performance. For example, the control-count value may be redetermined daily, weekly, fortnightly, monthly, bi-monthly, quarterly, bi-annually, annually, or biennially, depending on the rate of change of performance for the passive RFID tag.

In some examples, each control-count value could be stored with corresponding metadata. The metadata could, for example, include information indicative of how much time has passed since the control-count value was determined. The system may include logic that causes the control count to be re-determined if the metadata indicates that the amount of time since the control-count value was last determined exceeds a predetermined threshold.

In some examples, the stored control-count value could be tagged with an ID corresponding to the seat to which the corresponding passive RFID tag is attached. If users of the method and system disclosed herein report errors in the occupancy state determination for that seat, then the control-count value may be redetermined to improve the accuracy of the eventual determinations of the occupancy state for that seat. For example, the control-count value may be re-determined if the error-rate in occupancy determination exceeds a predefined threshold.

In some embodiments, the occupancy state of the seat includes a type of occupancy for each seat.

As discussed above, the occupancy types could include, for example, whether a seat is occupied by a person or by an inanimate object (e.g., a person's bag or coat). In this case, it may be possible to indicate to a user of the methods and systems disclosed herein that a seat is not actually occupied because it is occupied by an inanimate object as opposed to a person.

In some examples, the occupancy types could include the posture in which a person is occupying a seat. For example, the occupancy types could include: “leaning forward”, “leaning back”, “slouching”, “sitting upright”, or other occupancy types. This information could be useful, for example, in a commercial setting where it may be advantageous to determine if people are using seats in the office in a way that is suitable for long-term occupancy (e.g., if the people using the seats are sitting in those seats in a way complying with relevant health & safety guidelines) so that the users of the seats can be informed of their posture and encouraged to adopt a more suitable posture, i.e., “sitting upright”.

In some embodiments, each label associated with a labelled normalised count value may include metadata indicative of one or more properties of each passive RFID tag corresponding to a normalised count value in the labelled set, the one or more properties including one or more of: a position on the seat at which each passive RFID tag is attached to the seat; a unique identifier for each passive RFID tag; a date of manufacture for each passive RFID tag; a date on which each passive RFID tag was attached to the seat; an operating frequency or operating frequency range of each passive RFID tag; and/or a read range of each passive RFID tag.

Each of the parameters listed above may provide useful contextual information that facilitates an improved training of the machine learning algorithm.

For example, metadata indicative of a position on the seat at which each passive RFID tag is attached to said seat may enable the machine learning algorithm to identify differences that exist only between passive RFID tags placed on the same or similar positions of the seat, and/or disregard differences that arise from a passive RFID tag being moved such that it is attached at to the seat at a different position.

Similarly, metadata indicative of a unique identifier for each passive RFID tag may be useful because each passive RFID tag may emit response signals of a significantly different quantitative and qualitative nature (e.g., in terms of signal strength, signal duration, and phase) to that of another passive RFID tag. If such a passive RFID tag is identified then data related to that passive RFID tag may be disregarded for the purposes of training the machine learning algorithm to analyse response signals from different passive RFID tags.

Metadata indicative of a date of manufacture for each passive RFID tag and/or the date on which each passive RFID tag was attached to a seat may be useful because the machine learning algorithm could, in this way, be trained to recognise how the response signals emitted by a RFID tag change as the performance of the passive RFID tag changes (or degrades) overtime.

Metadata indicative of an operating frequency or operating frequency range of each passive RFID tag may be useful because it may enable the machine learning algorithm to discriminate variations in response signals that arise from differences in the operating frequency (e.g., because a particular frequency is less suitable for penetrating an obstacle between the passive RFID tag and a corresponding RFID reader).

Metadata indicative of a read range of each passive RFID tag may also be useful in training the machine learning algorithm to recognise when a response signal may not be received because the seat is out of read range from a corresponding RFID reader, as opposed to a response signal not being transmitted. The read range of a passive RFID tag may be understood to be the range over which a response signal emitted from said tag can be detected by a RFID reader.

In another aspect, there is provided a networked system for determining occupancy in a seating environment comprising a plurality of seats. The system comprises: a plurality of RFID tags attached to the seats, wherein each seat has a group of passive RFID tags attached thereto; and a computing apparatus communicatively linked with the plurality of RFID tags, the computing apparatus being configured to implement the methods described herein.

The methods disclosed herein may be implemented in this system in such a way as to determine occupancy state(s) of the seats in the seating environment of this system.

As discussed above, the system may comprise one or more RFID readers installed in the seating environment. RFID readers may be particularly straightforward and efficiently installable, both in terms of technical and cost considerations. The one or more RFID readers may, for example, be installed on a ceiling of the seating environment to ensure response signals from as wide a coverage area as possible can be received at each RFID reader.

The number of RFID readers deployed in the seating environment may depend, for example, on the size and/or geometry of the seating environment. For example, it may be preferable to position each of the one or more RFID readers at equidistant intervals along the ceiling of the seating environment. For example the interval may be 10 metres or more, 15 metres or more, 20 metres or more, 50 metres or more, or 100 metres or more.

In some embodiments, the system may further comprise one or more RFID antennae configured to broadcast the interrogation signal throughout the seating environment.

As discussed above, RFID antennae may be particularly straightforward and efficiently installable, both in terms of technical and cost considerations. The one or more RFID antennae may, for example, be installed on a ceiling of the seating environment to ensure as wide a coverage area as possible for each RFID antenna.

The number of RFID antenna deployed in the seating environment may depend, for example, on the size and/or geometry of the seating environment. For example, it may be preferable to position each of the one or more RFID antennae at equidistant intervals along the ceiling of the seating environment. For example, the interval may be 10 metres or more, 15 metres or more, 20 metres or more, 50 metres or more, or 100 metres or more.

In some embodiments, the computing apparatus may be part of a central server communicatively linked to the one or more RFID antennae over a 5G Internet of Things network, wherein the central server may be communicatively linked with the plurality of RFID tags via the one or more RFID antennae.

In this way, the high transfer speeds achievable with 5G networks can be leveraged in an interconnected Internet of Things network to reduce latency and improve processing speed, thereby allowing for real-time or near real-time determinations and/or monitoring of the occupancy state(s) within the seating environment.

In a further aspect, there is provided a computer-readable medium comprising instructions that, when executed by a computing apparatus, cause the computing apparatus to carry out the methods described herein.

In other words, the methods disclosed herein may be implemented by a computer to determine occupancy in a seating environment. As such, the present invention encompasses computer-readable media, and computer program products that comprise logic and/or instructions that, when executed by the processor of a computer, cause said computer to implement the methods disclosed herein.

The invention includes the combination of the aspects and preferred features described except where such a combination is clearly impermissible or expressly avoided.

### Activity Determination

In a general sense, the present invention provides methods and systems that are able to determine an activity being performed in an environment based on response signals received from a plurality of passive RFID tags arranged in the environment. The use of passive RFID tags would not normally be considered suitable for this purpose because of the large and random variation in signal strength and phase observed in signals emitted by passive RFIDs. The invention addresses and overcomes this technical limitation by demonstrating that it is in fact possible to determine a person's body position and movements based on variations in the number of passive RFID tag response signals received over a predetermined time period by each of the passive RFID tags.

The invention is set out in the appended set of claims.

In a first aspect, there is provided a method for determining an activity being performed by a person in an environment, the environment comprising a plurality of passive RFID tags. The method comprises: receiving, over a sample period, in response to an interrogation signal, one or more response signals from one or more of the passive RFID tags; determining, for each passive RFID tag, a normalised count value based on a number of response signals received from said passive RFID tag over the sample period; and using a machine learning algorithm to determine the activity being performed in the environment, the machine learning algorithm being configured to take the normalised count values as inputs, and determine, based on the normalised count values, the activity being performed in the environment during the sample period.

Advantageously, by basing the determination of the activity on normalised count values from a plurality of passive RFID tags, it is possible to discriminate between the small differences in the number of response signals received from each of the passive RFID tags arising from an activity being performed in the vicinity of the RFID tags. For example, by monitoring variations in the number of RFID responses between RFID tags over the sample period, the person's position and stance in the environment may be monitored. Moreover, as the person moves in and out of the detection ranges of each passive RFID tag, this movement may also be reflected in a change of the normalised count value between RFID tags. Accordingly, the method enables not only the presence of a person in the environment to be determined, but also what that person is doing.

This consequently facilitates a determination of activity in the environment using passive RFID tags which are both inexpensive and readily available in large quantities. Moreover, activities being performed in the environment may be determined more privately than existing methods of activity monitoring since neither footage of the person or communication with the person in the environment is required.

In some examples, the method for determining an activity may include continuous or substantially continuous monitoring of activities being performed in the environment. For example, the method may include continuously monitoring a person's movements and/or activity level in the environment, and reporting the activity level (e.g., to users) in real-time or near real-time.

The methods disclosed herein may be applied to determining activities across a broad range of environments. The environment may be an indoor environment such as a room in, e.g., a home or an office. The environment may be configured for Ambient Assisted Living, AAL, wherein the determined activity is provided to an assistance system for determining an assistance measure to be offered to the person based on the determined activity. For example, the method may be used to determine an elderly or disabled person's activities for monitoring their status and/or to inform an assistance system.

The plurality of RFID tags may be spatially separated in the environment. In this way, variations in the normalised count values between individual RFID tags may be used to determine areas in the environment (in the vicinity of each RFID tag) which do or do not contain an obstacle, such as part of the person. Accordingly, the person's body position may be determined from the normalised count values and hence an activity may be determined from the variations in the normalised count values over the sample period.

The environment may comprise a detection zone. The detection zone may be an area of the environment where the activity to be detected is performed. The plurality of RFID tags may be located adjacent to the detection zone (i.e., outside of the detection zone) such that the interrogation signal and/or the one or more response signals are received via the detection zone. Accordingly, the interrogation signal may be received by the passive RFID tags after propagation through the detection zone. Likewise, the one or more response signals may be received from the passive RFID tags after propagation through the detection zone. In this way, the interrogation signal and/or the one or more response signals may be disrupted by the presence of a person in the detection zone, thereby affecting the normalised count value of RFID tags in the vicinity of the person. Accordingly, the machine learning algorithm may be configured to determine an activity being performed in the detection zone of the environment.

The environment may further comprise an antenna configured to interact with the RFID tags (referred to herein as an “RFID antenna”). The RFID antenna may be configured to broadcast the interrogation signal through the environment to the plurality of RFID tags. The RFID antenna may be one or more, or a plurality of, RFID antennae configured to broadcast the interrogation signal through the environment. The RFID may be configured to broadcast the interrogation signal through a detection zone of the environment to the RFID tags. The RFID antenna may comprise a single antenna or an multi-antenna array.

The environment further comprises an RFID reader (or a plurality of RFID readers) configured to receive the one or more response signals from the RFID tags. The one or more response signals may be received via the detection zone. In some examples, an RFID antenna for broadcasting the interrogation signal may also be an RFID reader for receiving the one or more response signals.

When the environment comprises a detection zone, the plurality of RFID tags may be located on a first side of the detection zone, and an RFID antenna (for broadcasting the interrogation signal and/or receiving the one or more response signals) may be located on a second side of the detection zone. Therefore, the interrogation signal (and/or the one or more response signals) may be broadcast through the detection zone.

The second side of the detection zone may be an opposite side of the detection zone to the first size. Accordingly, the RFID antenna may be configured to face the plurality of RFID tags across the detection zone.

A stand-off distance between the RFID antenna and the plurality of passive RFID tags may be between 2m to 5m, more preferably between 3m to 4m, more preferably 3.5m. The stand-off distance may be a horizontal distance between the RFID antenna and a wall comprising the plurality of RFID tags. This stand-off distance between the RFID and the RFID tags enables a useful amount of detail about a person's activities in the detection zone to be detected. The present inventors have found that locating the RFID antenna at these distances from the RFID tags improves the overall accuracy of the method for determining the activity compared to if the RFID antenna was located closer to or further away from the RFID tags.

A spatial separation between each of the plurality of passive RFID tags in the environment may be between 15 cm to 80 cm, more preferably 25 cm to 70 cm, more preferably 30 cm to 60 cm. In some examples, e.g., when the RFID tags are attached to wall as discussed in more detail below, a horizontal separation between the RFID tags may be smaller than a vertical separation between the RFID tags. For example, the horizontal separation may be between 15 cm to 45 cm, more preferably 25 cm to 30 cm, more preferably 30 cm, and the vertical separation between the RFID tags may be between 40 cm to 80 cm, more preferably 50 cm to 70 cm, more preferably 60 cm. This spatial separation between RFID tags facilitates a sufficient level of detail to be detected using the normalised tag counts for differentiating between different activities being performed by a person in the environment. Therefore, a more accurate determination of the activity may be acquired than if the RFID tags were spaced more widely or too closely.

The plurality of RFID tags may comprise at least 10 RFID tags, more preferably 15 RFID tags.

The plurality of RFID tags may be arranged in a planar array of passive RFID tags. Accordingly, the RFID tags may be located in a same plane, within the environment such as a wall, floor, or ceiling. Arranging the RFID tags in a planar array can facilitate the determination of the person's activity as the person moves relative to the planar array thereby moving into the vicinity of a different combination of RFID tags in the array depending on their position. Therefore a more accurate determination of the activity may be obtained since each RFID can have a different “view” of the detection zone.

The planar array may be a vertical array. The vertical array may be located on a wall of the environment. In this way, variations in the normalised count values may be more likely to reflect the movements of a person's movements in the environment. Additionally, by locating the RFID tags on a wall they may be less likely to be in the way or present an obstacle to people in the environment. However, in other examples, the planar array may be e.g., a horizontal array. For example, the horizontal array may be located in a floor or ceiling of the environment.

The planar array of passive RFID tags may be arranged in rows and columns to form a matrix. As mentioned above, a horizontal separation between RFID tags in row of the matrix may be between 15 cm and 45 cm, and a vertical separation between RFID tags in columns of the matrix may be between 40 cm and 80 cm. The matrix may comprise three rows and five columns of RFID tags for a total of 15 RFID tags. However, other numbers and arrangements of RFID tags may also be used.

The normalised count values may be determined over a plurality of sample periods. The plurality of sample periods may overlap. Accordingly, the method may further comprise: repeating the receiving and determining steps to determine normalised count values for one or more subsequent sample periods to provide a sequence of normalised count values over a plurality of sample periods.

Accordingly, the machine learning model may be configured to take the sequence of normalised count values as inputs, and determine, based on the sequence of normalised count values, the activity being performed in the environment during a most recent sample period. In other examples, the machine learning model may be configured to receive a single set of normalised count values received over a sample period as inputs, wherein the method comprises repeatedly using the machine learning model to determine an activity for each of a plurality of sample periods.

In order to implement the methods disclosed herein, the sample period over which responses to the interrogation signal are received from one or more of the passive RFID tags may be a time period long enough to receive a sufficient number of response signals to be able to discriminate between different activities in the environment based on the normalised count values determined based on the received response signals.

Each sample period may be a predetermined period of time. For example, each sample period may be (i.e., the length of each sample period may be) between 1 and 5 seconds, more preferably between 2 and 4 seconds, more preferably 3 seconds. By determining the normalised count values for the predetermined period of time, a determination of the person's activity may be acquired as opposed to simply determining their stance or position during one particular moment. Rather dynamic information relating to the person's movements (if they are moving) may be reflected in the variations of normalised count values for each sample period.

A sample separation time between the sample periods (i.e., between the start of each sample period and the start of a subsequent sample period) may be shorter than (the length of) each sample period. Accordingly, the sample periods may be overlapping sample periods. Therefore, a sample rate of the method may be determined by the sample separation time. Owing to the overlapping sample periods, one or more of the response signals used to determine the normalised count value for a first sample period may also be used to determine a normalised count value for a second sample period if they were received during an overlap period of the first and second sample periods. In this way, the activity may be determined and updated more frequently than if the sample periods didn't overlap.

The sample separation time may be between 0.5 seconds and 2 seconds, more preferably 1 second. Accordingly, an update rate of the method for determining the activity may be between 2 Hz and 0.5 Hz, more preferably 1 Hz. Therefore, in these examples, an activity being performed in the environment may be determined between every 0.5 to 2 seconds, more preferably every 1 second.

Each normalised count value may be provided as a tag read rate per second. For example, the method may comprise converting each normalised count value over a sample period to a tag read rate per second. For example, a normalised count value over a sample period may be converted to a tag read rate by dividing the normalised count value by the sample period (e.g., 3 seconds).

The machine learning algorithm may be a classifier configured to output one of a plurality of activities based on the normalised count values. The machine learning algorithm may be configured to output one of the plurality of activities at the sample rate (e.g., every 1 second).

The machine learning algorithm is configured to determine one or more of the following activities based on the normalised count values: walking forwards, walking backwards, sitting, and standing. Other activities may also be possible.

The machine learning algorithm may comprise one or more of: a Long Short-Term Memory (LSTM) model, a Convolutional Neural Network (CNN), a Hybrid model combining an LSTM and CNN, a Support Vector Machine (SVM), a Decision Tree, and a Random Forest model.

Preferably, the machine learning model comprises an LSTM. The LSTM may be configured to receive a sequence of normalised count values (or tag read rates per second) determined for a plurality of sample periods. In this way, more temporal information may be used to determine the activity thereby improving the accuracy of the model for determining activities. The present inventors have found that an LSTM model is particularly accurate at predicting activities based on normalised count values. In particular, the memory cells of LSTM models may retain and refer to older inputs in sequential data to determine an output. Therefore, the use of an LSTM in this context may increase the accuracy of predictions since activities may be determined based on previous predictions and the person's previous movements in the environment.

In some examples, the method may further comprise determining if a person is present in the environment. For example, the machine learning algorithm may be configured to determine if no activity is being performed in the environment or if no person is present in the environment, based on the normalised count values.

In some examples, determining if a person is present in the environment may comprise comparing the normalised count values to a threshold count. If all of (or at least a threshold number) of the normalised count values are higher than the threshold count, then the method may comprise determining that no person is present in the environment. Accordingly, if a large number of response signals (i.e., larger than the threshold) are received from every (or most) of the RFID tags then it may be determined that no one is present in the environment to disrupt the interrogation signal and/or the response signals. For example, the threshold count may be a control count value corresponding to a number of response signals expected to be received from each RFID tag when no one is present in the environment. For example, when the sample period is 3 seconds, the threshold count may be 36.

In some examples, an activity being performed by one or more, or by a plurality, of people in the environment may be determined. For example, the machine learning algorithm may be configured to take the normalised count values as inputs, and determine, based on the normalised count values, the activity being performed by a plurality of people in the environment during the sample period. When there are a plurality of people performing an activity in the environment, the machine learning may be configured to assign a subject identifier to each person identified in the environment and an activity prediction for each person.

In this way, the method may be more adaptable for accurately determining activities, even when more than one person is present in the environment.

In some embodiments, the method may further comprise: receiving, over a predetermined control time period, in response to the interrogation signal, one or more response signals from each passive RFID tag, wherein there is no activity being performed in the environment for the duration of the control time period; determining, for each passive RFID tag, a control-count value, the control-count value being an aggregate of the number of response signals received from said passive RFID tag over the control time period.

In some embodiments, the determining, for each passive RFID tag, a normalised count value for each sample period may comprise: comparing the number of response signals received from said passive RFID tag over the respective sample period with the control-count value for said passive RFID tag.

In some examples, the control time period may be equal in length to the sample period. This may make the determination of the normalised count values more reliable because each normalised count value is determined by comparing the control count value with a number of response signals received over an equivalent period of time.

In some examples, each normalised count value may be determined by determining a ratio of the number of response signals received from the corresponding passive RFID tag over the sample period and the control-count value for said passive RFID tag. By determining each of the normalised count values in this way, it may be possible to discriminate, based on the differing normalised count values, between different activities in the environment during each sample period.

The method may further comprise: storing, for each passive RFID tag, the determined control-count value. The control-count value for each passive RFID tag could be determined, for example, on initialisation or installation of each passive RFID tag in the environment so that it is possible to determine normalised count values based on the corresponding control-count value as soon as the installation of the RFID tags in the environment has been completed.

In some examples, the control-count value could be redetermined periodically, for example, to account for change over time (or degradation) in the passive RFID tag's performance. For example, the control-count value may be redetermined daily, weekly, fortnightly, monthly, bi-monthly, quarterly, bi-annually, annually, or biennially, depending on the rate of change of performance for the passive RFID tag.

In some examples, each control-count value could be stored with corresponding metadata. The metadata could, for example, include information indicative of how much time has passed since the control-count value was determined. The system may include logic that causes the control count to be re-determined if the metadata indicates that the amount of time since the control count value was last determined exceeds a predetermined threshold.

In some examples, the determining of the activity being performed in the environment may be carried out by a central server remote from the environment.

The method may further comprise generating a message comprising the determined activity. The message may be provided to a control interface or to a central server. For example, the message may comprise information about a length of time that a person has been performing a particular activity. Or the message may indicate that a person is moving towards a restricted area.

In some examples, (e.g., when the environment is part of an AAL system) the method may comprise triggering an assistance protocol based on the determined activity. For example, if the determined activity indicates a person is moving towards a stair, the triggered assistance protocol may comprise moving a stairlift towards the person. In other examples, if the determined activity indicates a person has not moved for an unusual period of time, the assistance protocol may comprise sending an inquiry to their personal device or providing an alert message to a central server.

In a further aspect, there is provided a method of training a machine learning algorithm to determine an activity being performed in an environment. The method comprises: providing an untrained machine learning algorithm configured to predict an activity being performed in an environment based on received normalised count values associated with a plurality of passive RFID tags located in the environment, wherein each normalised count value is based on a number of response signals received from a respective passive RFID tag over a predetermined time period in response to an interrogation signal; receiving training data, the training data comprising a plurality of labelled sets of normalised count values associated with a respective passive RFID tag, wherein each of the sets of normalised count values is labelled with a label indicative of the activity being performed in the environment during the sample period; training the machine learning algorithm by: applying the machine learning algorithm to the training data to predict an activity being performed in the environment for each labelled set; comparing, for each labelled set, the prediction of the machine learning algorithm with the label; and if the machine learning algorithm predicted a different activity to the activity indicated by the label: adapting the machine learning algorithm based on the received plurality of labelled normalised count values to improve the accuracy of the prediction; and repeating the training of the machine learning algorithm until the accuracy of the machine learning algorithm exceeds a predetermined threshold.

In this way, the machine learning algorithm introduced above in the first aspect can be particularly well trained and adapted to determining an activity based on the specific arrangement of RFID tags provided in the environment. The machine learning algorithm may be retrained at regular intervals to account for changes overtime (or degradation) in the performance of the passive RFID tags. In this way, the machine learning algorithm can be used in a way that maintains consistently accurate determinations of the activities in the environment.

Each normalised count value may be based on a comparison between number of response signals received from the respective passive RFID tag over the sample period, and a control-count value, the control-count value being an aggregate of a number of response signals received from the same passive RFID tag over a control time period in response to an interrogation signal, wherein the passive RFID tag may be located in an environment that is unoccupied for the duration of the control time period.

As discussed above, in some examples, the control time period may be equal in length to the sample period. This may make the determination of the normalised count values more reliable because each normalised count value is determined by comparing the control-count value with a number of response signals received over an equivalent period of time.

Each label of the labelled set of normalised count values may include metadata indicative of one or more properties of each passive RFID tag (corresponding to a normalised count value in the labelled set). The one or more properties may include one or more of: a position in the environment where each passive RFID tag is located; a unique identifier for each passive RFID tag; a date of manufacture for each passive RFID tag; a date on which each passive RFID tag was positioned in the environment; an operating frequency or operating frequency range of each passive RFID tag; and/or a read range of each passive RFID tag. Each of the parameters listed above may provide useful contextual information that facilitates an improved training of the machine learning algorithm.

For example, metadata indicative of a position in the environment where an RFID tag is located may enable the machine learning algorithm to identify differences that exist only between passive RFID tags placed on the same or similar positions (e.g., near to a side wall, or the floor/ceiling of the environment).

Similarly, metadata indicative of a unique identifier for each passive RFID tag may be useful because each passive RFID tag may emit response signals of a significantly different quantitative and qualitative nature (e.g., in terms of signal strength, signal duration, and phase) to that of another passive RFID tag. If such a passive RFID tag is identified then data related to that passive RFID tag may be disregarded for the purposes of training the machine learning algorithm to analyse response signals from different passive RFID tags.

Metadata indicative of a date of manufacture for each passive RFID tag and/or the date on which each passive RFID tag was installed in the environment may be useful because the machine learning algorithm could, in this way, be trained to recognise how the response signals emitted by a RFID tag change as the performance of the passive RFID tag changes (or degrades) overtime.

In a further aspect there is provided a method of assembling training data for use in training the machine learning model described in the previous aspects. The method comprises: providing a plurality of passive RFID tags in an environment, the environment comprising a person performing an activity, receiving, over a sample period, in response to an interrogation signal, one or more response signals from each of the passive RFID tags; determining, for each passive RFID tag, a normalised count value based on a number of response signals received from said passive RFID tag over the sample period, to provide a set of normalised count values of the sample period, labelling the set of normalised count values according to the activity being performed in the environment during the predetermined period of time, repeating the providing, receiving, determining and labelling steps, wherein a same or different activity is being performed in the environment during each repetition, to obtain a plurality of labelled sets of normalised count values as training data.

In this way, a database of normalised count values for each RFID tag can be assembled to build up a picture of how the normalised count values vary depending on which activity is being performed in the environment. Accordingly, the machine learning model can be trained, using the assembled data, to make predictions of activities based on these variations in the normalised count values which may not be possible if only the RSSI or phase of the RFID tags were monitored.

The method of assembling training data may further comprise: receiving, over one or more subsequent sample periods, one or more response signals from each of the passive RFID tags; and determining, for each sample period, a normalised count value for each passive RFID tag based on a number of response signals received from said passive RFID tag in the one or more subsequent sample period, to provide a sequence of normalised count values for each passive RFID tag over a plurality of sample periods. Therefore, each set of labelled normalized count values may comprise one or more sequences of normalised count values.

In this example, the machine learning algorithm may be trained by providing the sequences of normalised count values. In this way, the machine learning algorithm can learn to determine activities in the environment by accounting for relative variations in the normalised count values over time leading to more accurate activity determinations.

In some examples, each activity may be performed simultaneously by a plurality of persons in the environment. Therefore, the machine learning algorithm can be trained to determine activities when more than one person is in the environment, therefore providing a more adaptable activity monitoring system.

In a further aspect there is provided a system for determining an activity being performed in an environment. The system comprises: a plurality of passive RFID tags located in the environment; and a computing apparatus communicatively linked with the plurality of RFID tags, the computing apparatus being configured to implement the methos discussed herein.

The methods disclosed herein may be implemented in this system in such a way as to determine an activity (or activities) being performed in the environment of this system.

As discussed above, the system may comprise one or more RFID readers installed in the environment. The one or more RFID readers may, for example, be installed on a ceiling of the environment to ensure response signals from as wide a coverage area as possible can be received at each RFID reader. In some examples, the one or more RFID readers may be installed on an opposite side of a detection zone from the plurality of RFID tags, wherein the activity being determined may performed in the detection zone (i.e., so that the system is configured to determine an activity in a detection zone between the RFID tags and RFID reader).

The system may further comprise an antenna (e.g. the RFID antenna discussed above) configured to broadcast the interrogation signal throughout the environment. The antenna, may be configured to broadcast the interrogation signal to the plurality of passive RFID tags through a detection zone of the environment.

For the avoidance of doubt, the skilled person would understand that any features discussed above in relation to the first aspect may be included in the system of the first aspect where applicable. For example, the plurality of passive RFID tags may be located in a planar array. Further, a distance between the one or more RFID antennas and the planar array may be between 1.5 m and 5m.

Further, in examples, where RFID readers are also deployed in the environment, it may be preferable to deploy a RFID reader in proximity to an RFID antenna, i.e., the RFID readers and RFID antennae may be deployed in pairs. In such examples, the RFID reader(s) may only be activated if and when the corresponding RFID antenna(e) are actively broadcasting an interrogation signal.

In some examples, the system may be a networked system. For example, the networked system may be configured to communicate the determined activity to a central server.

In some examples, the computing apparatus may be part of a central server communicatively linked to the one or more RFID antennae over a network. The central server may be communicatively linked with the plurality of RFID tags via the one or more RFID antennae.

For example, the computing apparatus may be communicatively linked to the one or more RFID antennae over a 5G Internet of Things network. In this way, the high transfer speeds achievable with 5G networks can be leveraged in an interconnected Internet of Things network to reduce latency and improve processing speed, thereby allowing for real-time or near real-time determinations and/or monitoring of activities in the environment.

In a further aspect, there is provided a computer-readable medium comprising instructions that, when executed by a computing apparatus, cause the computing apparatus to carry out the methods described herein.

In other words, the methods disclosed herein may be implemented by a computer to determine an activity being performed in an environment. As such, the present invention encompasses computer-readable media, and computer program products that comprise logic and/or instructions that, when executed by the processor of a computer, cause said computer to implement the methods disclosed herein.

The invention includes the combination of the aspects and preferred features described except where such a combination is clearly impermissible or expressly avoided.

### SUMMARY OF THE FIGURES

Embodiments and experiments illustrating the principles of the invention will now be discussed with reference to the accompanying figures in which:

FIG. 1a shows an example of an RFID reader an RFID antenna installed in a seating environment for determining the occupancy of said seating environment.

FIG. 1b shows an example of a seat in a seating environment with three passive RFID tags attached thereto.

FIG. 1c shows an example of a graphical user interface depicting occupancy states of seats in a seating environment.

FIG. 2a shows an example of a seating environment in a public transport setting.

FIG. 2b shows an example of a seat in the seating environment of FIG. 2a, with a passive RFID tag attached thereto.

FIG. 3 shows a schematic of the communication protocol between passive RFID tags and RFID readers and/or antennae in a seating environment.

FIG. 4 shows a schematic of a networked system configured to implement the methods disclosed herein.

FIG. 5a shows a plot of RSSI values for response signals collected over time during a collection run of response signals from a passive RFID tag attached to a seat in a seating environment.

FIG. 5b shows a plot of the density of RSSI values of the response signals depicted in FIG. 5a.

FIG. 5c shows a plot of RSSI values for response signals collected over time during a second collection run of response signals from the same passive RFID tag as in FIG. 5a.

FIG. 5d shows a plot of the density of RSSI values of the response signals depicted in FIG. 5c.

FIG. 6a shows a plot of the phase values of response signals collected overtime during the collection run depicted in FIG. 5a.

FIG. 6b shows a plot of the phase values of response signals collected over time during the collection run depicted in FIG. 5c.

FIG. 7 shows a plot of the density of RFID signals received over a collection run from a passive RFID tag attached to a seat in a seating environment.

FIG. 8 shows a schematic of example machine learning and deep learning models that may be applied to the normalised count values in accordance with embodiments of the methods disclosed herein.

FIG. 9 shows an example processing architecture adapted to implement the methods disclosed herein.

FIG. 10 shows a method for determining occupancy in a seating environment.

FIG. 11 shows a method for training a machine learning algorithm to determine an occupancy state of a seat in a seating environment.

FIG. 12 shows an example of an RFID reader an RFID antenna installed in an environment for determining an activity being performed in an environment;

FIGS. 13A-13D show a person performing various activities in the environment;

FIGS. 14A-14D show probability density plots of RSSI values overtime for two different runs for multiple RFID tags;

FIGS. 15A-15B show probability density plots of RSSI values for the tags of FIGS. 14A to 14D on the same plots for two different runs;

FIGS. 16A-16D show density plots for the inter-arrival times of received signals from passive RFID tags across several runs;

FIG. 17A-17B show heat maps of count values for the plurality of passive RFID tags for two different activities being performed in the environment;

FIGS. 18A-18D show distributions of the count values for each passive RFID tag in a row of a vertical array of RFID tags;

FIGS. 19A-19D show distributions of the count values for each second of a sample period for the passive RFID tags of FIGS. 18A-18D;

FIG. 20 shows a flow diagram of a method for collecting training data and using that training data to train the machine learning model for determining activities;

FIG. 21 shows a plot of model accuracy compared to a stand-off distance of the RFID antenna;

FIG. 22 shows a method for determining a person's activities in the environment; and

FIG. 23 shows a method for training a machine learning algorithm to determine an activity in an environment.

### DETAILED DESCRIPTION OF THE INVENTION

Aspects and embodiments of the present invention will now be discussed with reference to the accompanying figures. Further aspects and embodiments will be apparent to those skilled in the art. All documents mentioned in this text are incorporated herein by reference.

### Occupancy Monitoring

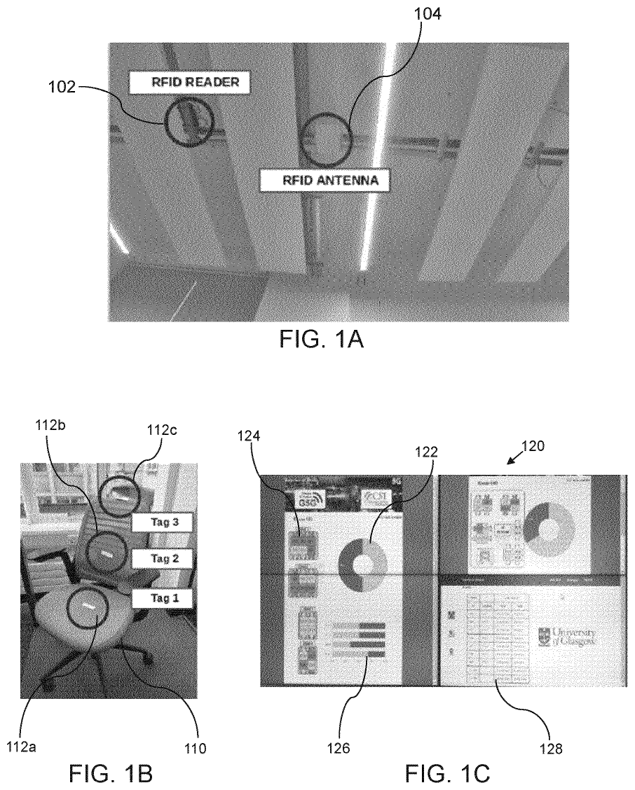

FIG. 1a shows an example of an RFID reader 102 and an RFID antenna 104 installed in a seating environment for determining the occupancy of said seating environment. As can be seen in FIG. 1, the RFID reader 102 and RFID antenna 104 may be installed on a ceiling of the seating environment to ensure as wide a coverage area as possible for both the RFID reader 102 and the RFID antenna 104. In some examples, multiple RFID readers and/or multiple RFID antennae may be installed in the seating environment to ensure a complete coverage of the seating environment. For example, the RFID readers 102 and RFID antennae 104 may be placed in pairs at equidistant intervals throughout the seating environment (e.g., at intervals of 10 metres or more, 15 metres or more, 20 metres or more, 50 metres or more, or 100 metres or more along the ceiling).

Additionally, in seating environments where walls and other boundaries/obstacles (e.g., pillars) comprise metallic (or otherwise electrically conductive) elements, it may be advantageous to position the one or more RFID antennae such that there is always at least one direct line of communication between each passive RFID tag (the tags being discussed below in relation to FIG. 1b and other figures). This is because electrically conductive materials may block radio frequency signals being transmitted between the RFID reader(s) 102 and the passive RFID tags, and between the RFID antenna(e) 104 and the passive RFID tags.

FIG. 1b shows an example of a seat 110 in a seating environment with three passive RFID tags 112a-c spaced apart and attached thereto. In the example shown in FIG. 1b, the seat 110 is in a seating environment that is part of a commercial setting such as an office, although other settings (e.g., educational settings such as lecture theatres, classrooms, and libraries) may implement similar configurations. A first passive RFID tag 112a is attached to the seat 110 at a base section of the seat 110 corresponding to the section of the seat 110 that a seated person would sit upon. A second passive RFID tag 112b is attached to the seat 110 at a lower back section of the seat corresponding to where the lower back of a seated person would contact (or come into proximity to) the seat 110 in use. A third passive RFID tag 112c is attached to the seat 110 at an upper back/head section of the seat 110 corresponding to where the upper back, neck, or head of a seated person would contact (or come into proximity to) the seat 110 in use. In other settings and configurations, different numbers of passive RFID tags may be attached to the seat 110 in different locations.

Each of the passive RFID tags 112a-c may be printed on an inkjet printer using known methods. In this way the passive RFID tags 112a-c can be cheaply and quickly mass-produced for installation in high-occupancy seating environments as needed.

Each of the passive RFID tags 112a-c is configured to transmit a response signal that may be detected by the one or more RFID readers in the seating environment. This response signal is generated and transmitted in response to the corresponding passive RFID tag 112a-c receiving an interrogation signal that is broadcast by at least one of the one or more RFID antennae 104 installed in the seating environment.

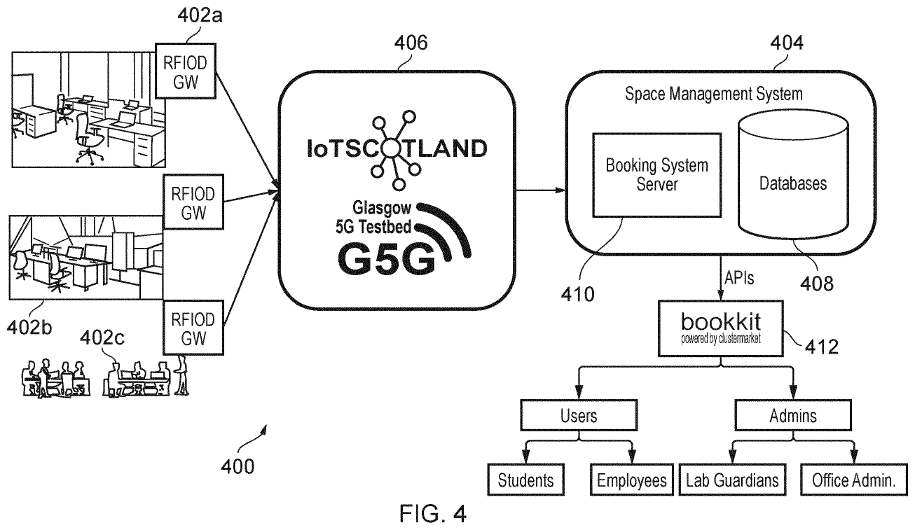

In some examples, the RFID reader 102 may be connected to a hardware embedded board configured to transmit received response signals to a central server (see below in relation to FIG. 4) so that the response signals can be processed according to the methods described herein.

FIG. 1c shows an example of a graphical user interface 120 depicting occupancy states of seats 110 in a seating environment. The graphical user interface may display information 122 indicative of the proportion of seats in the seating environment that are occupied. Additionally or alternatively, the graphical user interface may display information 124 in the form of a map that is indicative of which seats 110 in the seating environment are occupied and which are not. Additionally or alternatively, the graphical user interface may display information 126 indicative of how the proportion of occupied seats 110 varies on a day-to-day basis. In some examples, the information display by the graphical user interface 120 may be colour-coded (e.g., green indicating an unoccupied seat, and red indicating an occupied seat), and/or presented in the form of a table 128 indicating the number of occupied and unoccupied seats in each section of the seating environment.

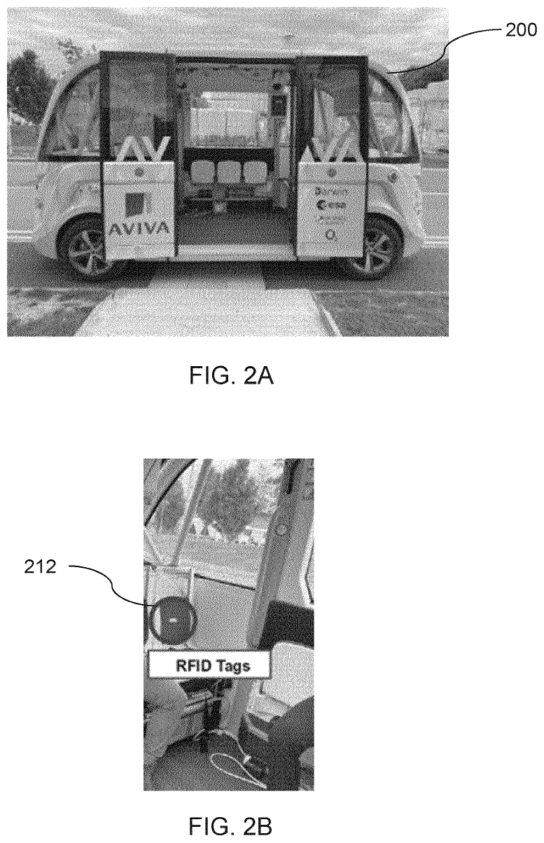

FIG. 2a shows an example of a seating environment 200 in a public transport setting. In the case depicted in FIG. 2a, the seating environment includes seats on a self-driving shuttle bus. Such a setting may particularly benefit from the methods disclosed herein because the self-driving vehicle may, in some cases, be configured to only permit new passengers to board the vehicle if it is determined that there are unoccupied seats onboard.

FIG. 2b shows an example of a set 210 in the seating environment 200 of FIG. 2a, with a passive RFID tag 212 attached thereto. The passive RFID tag 212 may be configured in the same way as the passive RFID tags 212a-c described above in relation to FIG. 1b to communicate with an RFID antenna and/or RFID reader installed on the ceiling of the self-driving vehicle. Of course, it will be appreciated that the same system and methods may be implemented in other public transport vehicles, including those that are staffed/driven by a person such as trains, coaches and buses.

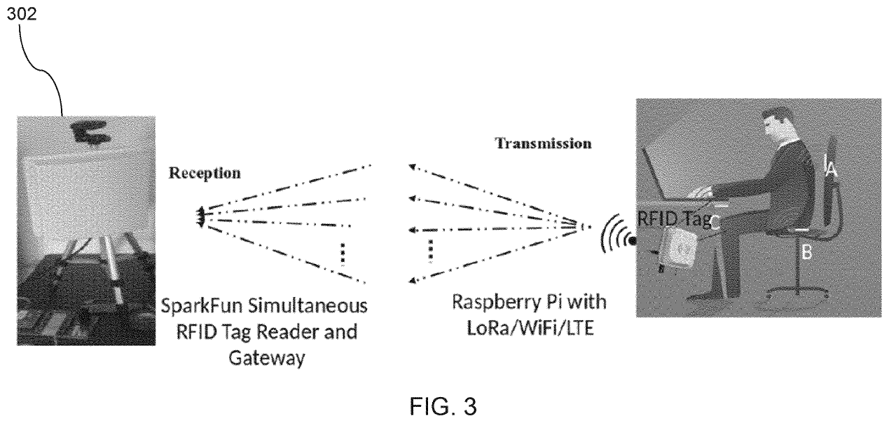

FIG. 3 shows a schematic of the communication protocol between passive RFID tags and RFID readers and/or antennae in a seating environment such as those depicted in FIGS. 1 and 2. FIG. 3 shows that the response signals transmitted from the one or more passive RFID tags 112a-c, 212 are picked up by at least one of the one or more RFID readers 102, or possibly at least one of the one or more RFID antennae 104. A hardware embedded board connected to said reader/antenna 102/104 (also referred to herein as a gateway) then transmits the signal over network to a cloud server and database 302. In some implementations, the hardware embedded board may be provided using a Raspberry Pi-type architecture, or similar. In some examples, the cloud server and database 302 may be implemented on a 5G test bed. In such examples, the one or more gateways can send signals to the 5G test bed through the hardware embedded boards. The signals may also be transmitted through other protocols including Long-Range Wide-Area-Network (LoRaWAN), WiFi, or LTE protocols. The data transmitted to the central server and database 302 may be stored in a space management server-based database that can be accessed through different dashboard APIs such that a user of an API can identify the occupancy and/or activity of the seating environment and be shown a dashboard including information relating to the seating environment and, optionally, individual seats within said seating environment.

FIG. 4 shows a schematic of a networked system 400 configured to implement the methods disclosed herein. The networked system 400 comprises a plurality of seating environments 402a-c communicatively linked to a space management system 404 (or central server) via a 5G Internet of Things (IoT) test bed 406. The gateways in the seating environments 402a-c are configured to send response signals from the passive RFID tags therein to the space management system 404 via the 5G IoT test bed 406. The space management system 404 may comprise one or more databases 408 for storing the signals received from the seating environments 402a-c, and a booking system server 410. The booking system server 410 may be accessible by a user via one or more APIs 412 in order to book seats in one or more of the seating environments 402a-c that are determined as being unoccupied according to the methods disclosed herein. Broadly, the users of the system accessing the booking system server 410 via the one or more APIs may be divided broadly into two categories: ‘Users’ and ‘Admins’. Users may be personnel with access privileges that enable them to view the occupancy states of seats in one or more of the seating environments 402a-c and book seats that are determined as being unoccupied. Meanwhile, Admins may have additional rights that allow them to manually change occupancy states, restrict or increase Users' access privileges (e.g., in terms of which seating environments they are able to view and book on the one or more APIs 412), and perform other administrative tasks.

The systems and networks described above in relation to FIGS. 1 to 4 represent suitable systems for implementing methods for determining occupancy states of seating environments based on identifying small differences in response signals received from one or more groups of passive RFID tags, said response signals being emitted in response to an interrogation signal from one or more RFID antennae.

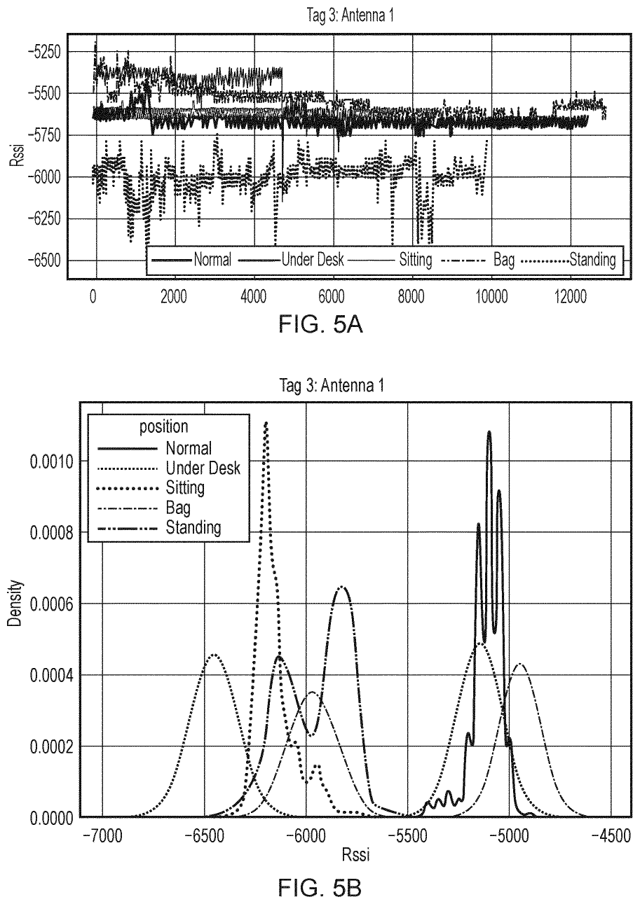

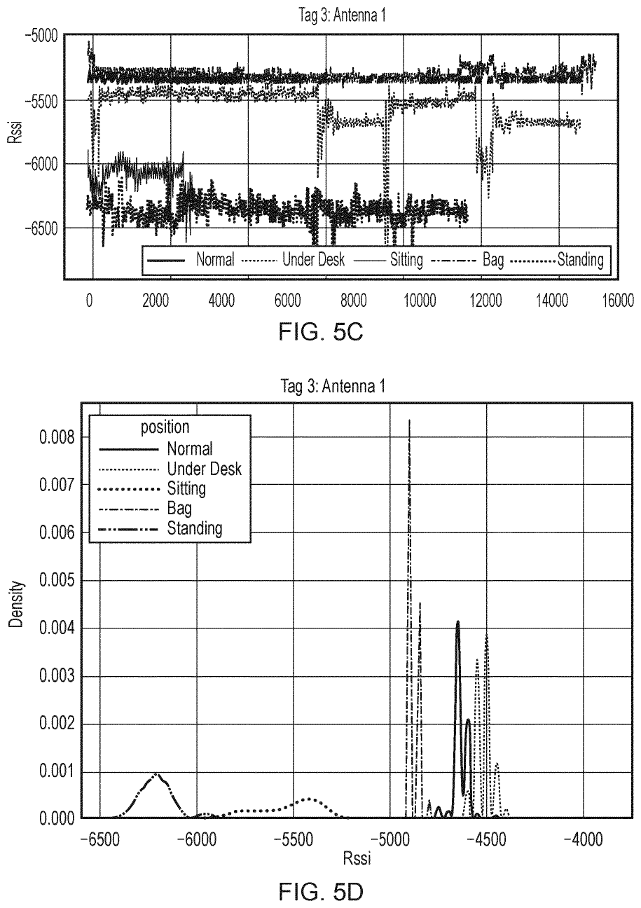

FIG. 5a shows a plot of RSSI (received signal strength indicator) values for a first set of response signals collected overtime during a collection run of response signals from a passive RFID tag attached to a seat in a seating environment. The data plotted in FIG. 5a shows example data of RSSI values collected from a same passive RFID tag over a predetermined period of time, where each line on the plot corresponds to a different occupancy state of the seat to which the passive RFID tag is attached. The occupancy states for which data has been collected and plotted in FIG. 5a are: “Normal” indicating an unoccupied seat, “Under Desk” indicating an unoccupied seat that has been tucked under a desk, “Sitting” indicating a person sitting in the seat, “Bag” indicating a bag or other inanimate object has been placed on the seat, and “Standing” indicating a person standing at a desk next to the seat.

FIG. 5b shows a plot of the density of RSSI values collected over the time period plotted in FIG. 5a. As can be seen from FIG. 5b, the density of RSSI values for each occupancy state take the form of bi-modal or multi-modal distributions with the distributions seemingly randomly changing between occupancy states.

FIG. 5c shows a plot of RSSI values for a second set of response signals collected over time for the same passive RFID tag for which data has been plotted in FIG. 5a, but on a different set of collection runs. It is apparent from FIG. 5c that there is no obviously apparent correlation between collection runs on an RFID tag, and particularly there appears to be no obvious correlation within occupancy types across different collection runs, even of the same passive RFID tag.

This is further supported by the plot in FIG. 5d that shows the density of RSSI values of the response signals plotted in FIG. 5d. Here, it can be seen that the density plots in FIG. 5d are seemingly uncorrelated with the density plots plotted for the first set of collection runs in FIG. 5b.

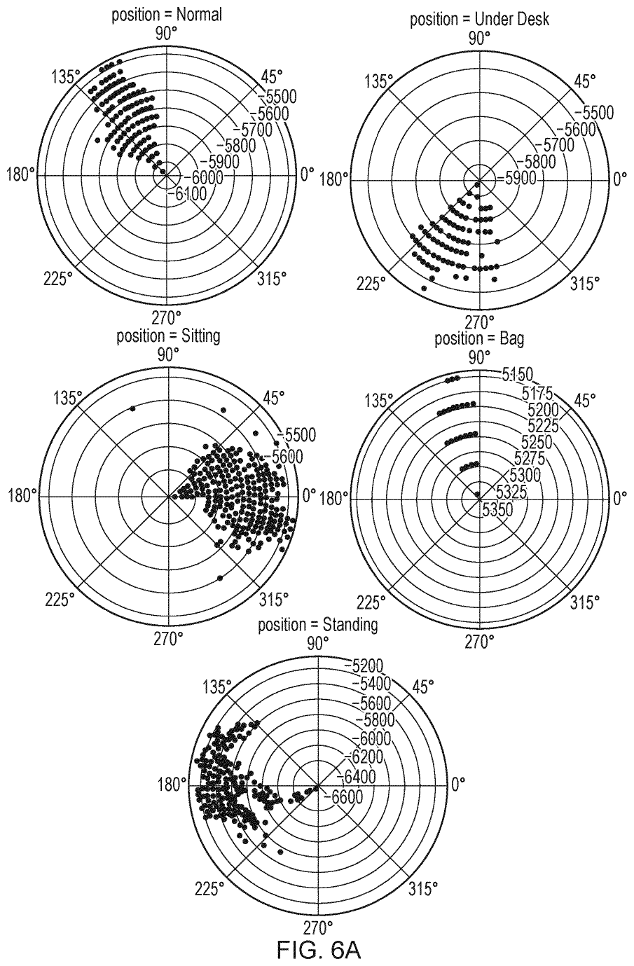

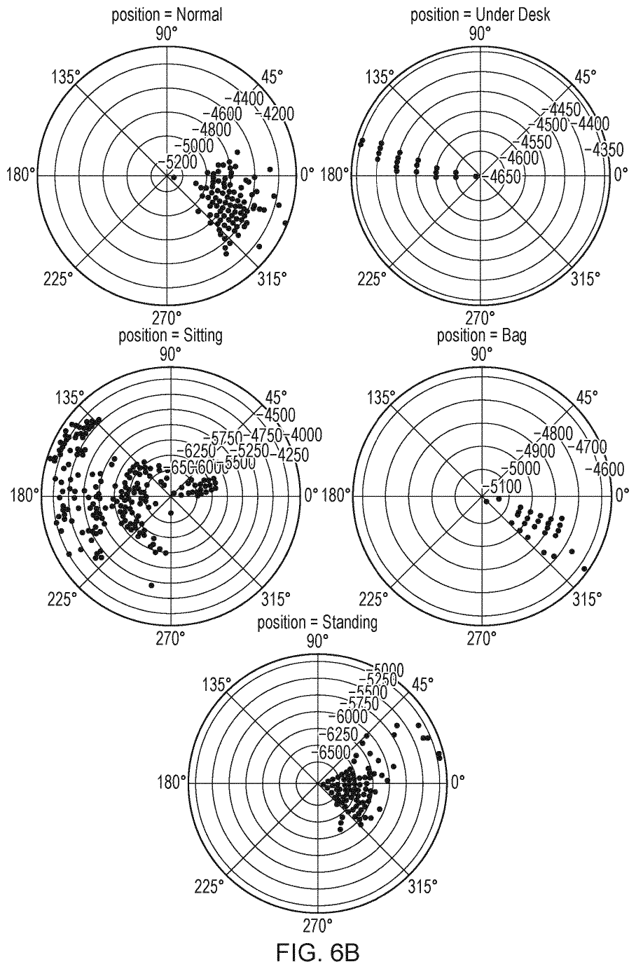

Similarly, FIGS. 6a and 6b show plots of the phase values of response signals collected overtime during the collection runs depicted in FIGS. 5a and 5c respectively. While it is seemingly apparent that the phases are correlated within a single collection run for a given occupancy type, by comparing FIGS. 6 and 6b there does not appear to be an obvious correlation between the phase values within occupancy types across different collection runs.

In other words, across different collection runs and occupancy types, the distribution of phase values and signal strength (as indicated by RSSI values) appears to show random variations and a lack of determinism which would ordinarily be required to utilise these values for prediction or detection.

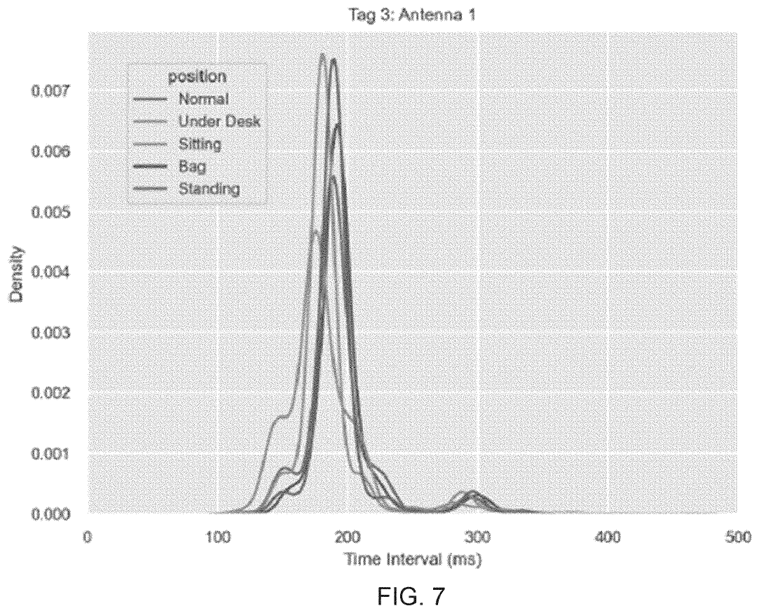

FIG. 7 shows a plot of the density of RFID signals received over a collection run from a passive RFID tag attached to a seat in a seating environment. In the plot shown in FIG. 7, the density of RFID signals is representative of a normalised count value for the number of response signals received from the passive RFID tag over a predetermined time period. In the example shown in FIG. 7, the predetermined time period is 0.5 seconds, although in some practical implementations this time period may be approximately 10 seconds.

The normalised count value may be determined by carrying out the following method. First, a number of response signals received from the passive RFID tag over a predetermined time period is counted. Second, this number of received response signals is compared with a control-count value—preferably by taking a ratio (i.e., dividing) of the number of received response signals and the control-count value. The control-count value may be determined as the aggregated number of response signals received from the same passive RFID tag over a control time period, the control time period being a time period during which the passive RFID tag is known to be unoccupied. This control time period is preferably a period of time equal in length to the predetermined time period over which the response signals were received. In this way, the normalised count value for each collection run on a passive RFID tag can be considered to be normalised with respect to response performance of that same passive RFID tag during a time for which the seat to which said tag is attached is known to be unoccupied, and wherein the entire seating environment is known to be empty.

In some examples, the control count value may be an average of a series of previously determined control count values.

In some examples, the control count value may be a maximum count of response signals received during the control time period, wherein that control time period is one of a plurality of equal time periods in a user-set calibration phase of the passive RFID tag. Typically, this maximum count is achieved in scenarios when the entire seating environment is empty and non-moving

By determining the control count value as described above, it is possible to remove any variations in the normalised count values that may arise due to different passive RFID tags being printed in different batches, or any effects arising from the age or quality of the passive RFID tags.

The methods described herein for determining the occupancy state(s) of seat(s) in seating environments are based on discriminating between the small differences in the normalised count values for different occupancy states, such as those depicted in FIG. 7.

In some examples, this may involve leveraging the computing and processing capabilities associated with machine learning and deep learning algorithms.

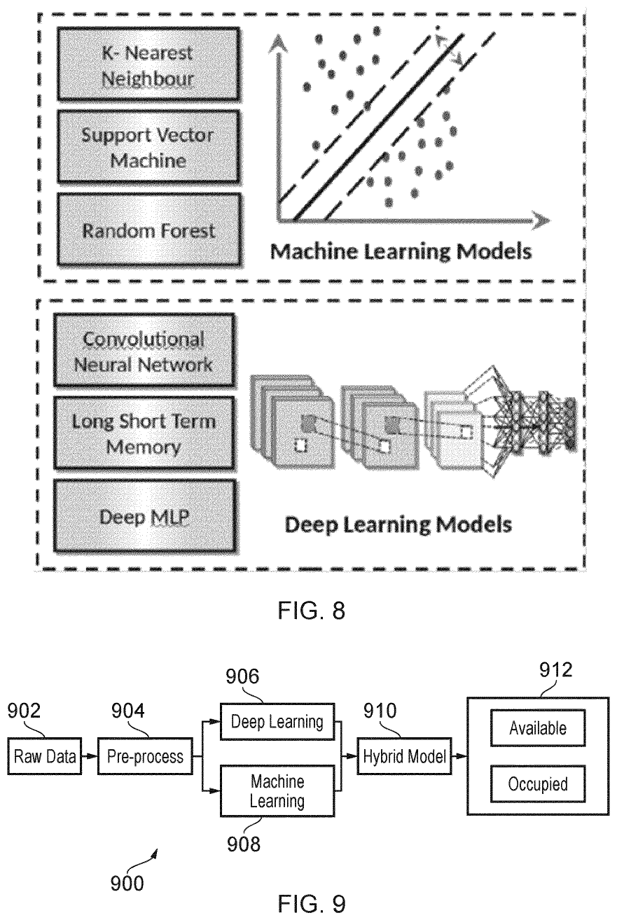

FIG. 8 shows a schematic of example machine learning and deep learning models that may be applied to the normalised count values In order to determine occupancy states of seats in the seating environments described above.

As can be seen in FIG. 8, the machine learning algorithms may include K-nearest neighbour (KNN) algorithms, support vector machines, and random forest algorithms, amongst other architectures. Meanwhile the deep learning algorithms may include convolutional neural networks, long short term memory algorithms, and (deep) multi-layer perceptrons, amongst other algorithms.

FIG. 9 shows one particular example processing architecture 900 adapted to determine occupancy states of seats in a seating environment.

The processing architecture 900 is configured to receive raw data 902 as an input. The raw data include the raw count values of response signals received from the passive RFID tags attached to seats in the seating environments. The processing architecture is configured pre-process 904 this raw data to determine the normalised count values discussed above in relation to FIG. 7.

These normalised count values may then be processed in parallel by deep learning 906 and machine learning 908 components of the processing architecture 900, such as those described above in relation to FIG. 8. The outputs of the deep learning 906 and machine learning 908 components may be fed into a hybrid model 910 to finally yield an output 912 that includes a determination of the occupancy state(s) of the seat(s) within the seating environment.

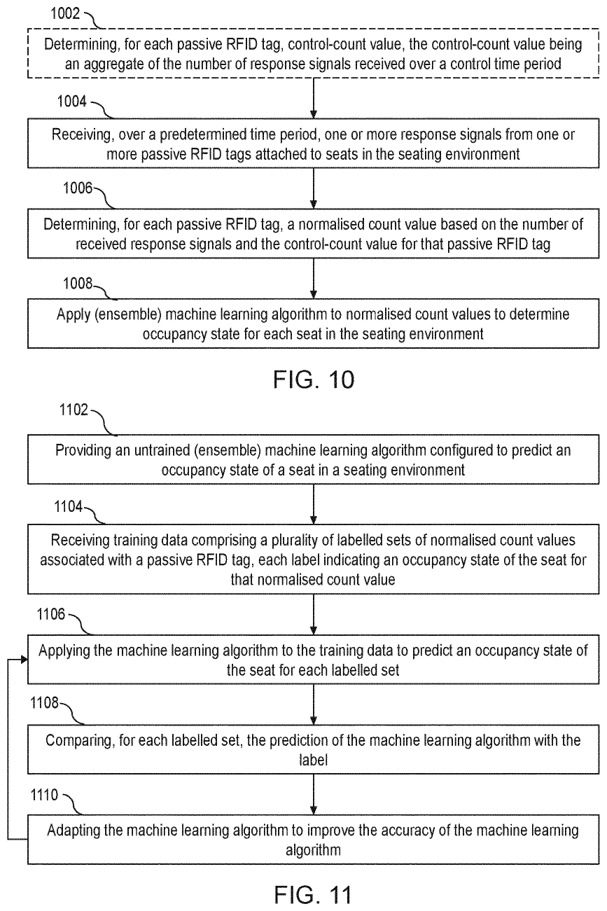

FIG. 10 shows a method for determining occupancy in a seating environment. The method includes, in operation 1002, optionally determining for each passive RFID tag attached to a seat in a seating environment, a control-count value, as described above.

The method further includes, in operation 1004, receiving, over a predetermined time period, one or more response signals from one or more of the passive RFID tags attached to seats in the seating environment. These one or more response signals may be emitted by the passive RFID tags in response to receiving an interrogation signal from an RFID antenna installed in the seating environment, e.g., on the ceiling of the seating environment.

The method further includes, in operation 1006, determining for each passive RFID tag, a normalised count value based on the number of received response signals and the control-count value for that passive RFID tag. As discussed above, it is the small variations in the normalised count values that enables determination of the occupancy state(s) of seats in the seating environment.

The method further includes, in operation 1008, applying a machine learning algorithm (preferably an ensemble machine learning algorithm as set out below), to the normalised count values to determine occupancy states for each seat in the seating environment.

The machine learning algorithm may be configured to consider groups of passive RFID tags—for example, the normalised count values may be grouped such that all of the passive RFID tags that are attached to the same seat are grouped together and the machine learning algorithm is configured to determine the occupancy state of that seat based on the normalised count values of all of the REID tags attached thereto.

The table below shows the performance statistics for a variety of different machine learning algorithms applied to normalised count values to determine occupancy states of seats in a seating environment.

| | | | | F1- |
|---|---|---|---|---|
| | Accuracy | Precision | Recall | Score |
| Classifier | (%) | (%) | (%) | (%) |
| Decision Tree (DT) | 94.64 | 90.32 | 92.62 | 91.41 |
| Extremely Randomized | 93.80 | 89.14 | 90.93 | 90.00 |
| Trees (ET) | | | | |
| Quadratic Discriminant | 89.57 | 81.83 | 90.09 | 84.87 |
| Analysis (QDA) | | | | |
| Ridge | 93.52 | 88.56 | 90.76 | 89.60 |
| Linear Support Vector | 87.61 | 79.69 | 90.63 | 82.98 |
| Machine (SVM) | | | | |
| Stochastic Gradient Descent | 93.80 | 89.14 | 90.93 | 90.00 |
| (SGD) | | | | |
| Neighbourhood Component | 94.65 | 90.97 | 91.45 | 91.21 |
| Analysis (NCA) + KNN | | | | |
| Bernoulli Naïve Bayes (NB) | 93.80 | 89.76 | 89.76 | 89.76 |
| Gaussian NB | 90.70 | 83.41 | 90.20 | 86.12 |
| Random Forest (RF) | 94.65 | 90.63 | 92.04 | 91.31 |
| Multi-layer Perceptron (MLP) | 94.92 | 90.00 | 95.00 | 92.00 |
| Super Learner Ensemble | 97.16 | 93.70 | 96.35 | 95.01 |

In the examples shown in the table, accuracy may be determined as:

$$Accuracy = \frac{TP + TN}{TP + TN + FP + FN}$$

Precision may be determined as:

$$Precision = \frac{TP}{TP + FP}$$

Recall may be determined as:

$$Recall = \frac{TP}{TP + FN}$$

and F1-score may be determined as:

$$F 1 = 2 \times \frac{Precision \times Recall}{Precision + Recall}$$

wherein TP represents the number of true-positive determinations, TN represents the number of true-negative determinations, FP represents the number of false-positive determinations, and FN represents the number of false-negative determinations. In this instance a “positive” determination is a determination that a seat is occupied, while a “negative” determination is a determination that a seat is unoccupied.

The super learner ensemble referred to in the last row of the table above can be seen to be a particularly accurate algorithm for determining the occupancy state(s) of seat(s) in the seating environment, with particularly high precision, recall, and F1-score. Maximising each of these parameters is a strong indicator of optimised performance for an algorithm.

This super learner ensemble utilises four base classifiers: a support vector machine, a ridge classifier, a stochastic gradient descent algorithm and a multi-layer perceptron. The super learner ensemble further comprises an additional multi-layer perceptron stacked on top of these four base classifiers. The inventors have found that this heterogeneous structure performs particularly well for the purposes of the methods described herein.

FIG. 11 shows a method for training a machine learning algorithm to determine an occupancy state of a seat in a seating environment. A first operation 1102 of the method for training includes providing an untrained machine learning algorithm (and preferably the super learner ensemble algorithm discussed above) that is configured to predict an occupancy state of a seat in a seating environment based on normalised count values received from passive RFID tags attached thereto in accordance with the method set out in relation to FIG. 10 above.

A further operation 1104 involves receiving training data that comprises a plurality of labelled sets of normalised count values associated with a passive RFID tag attached to a seat. The label on each labelled set is indicative of an occupancy state of the seat for that normalised count value. For example, the label may identify if the normalised count value was determined for a seat that is: occupied, unoccupied, occupied by an inanimate object (e.g., a bag or a coat), or a type of occupancy by a person (e.g., leaning forward, leaning back, slouching, sitting upright), or other occupancy types.

Each label may further comprise metadata indicative of one or more properties of each passive RFID tag corresponding to each normalised count value in the labelled set. These properties may include one or more of: a position on the seat at which the corresponding passive RFID tag is attached; a unique ID (e.g., manufacturer's batch ID) for the corresponding passive RFID tag; a date of manufacture of the corresponding RFID tag; a date on which each passive RFID tag was attached to a seat in the seating environment; an operating frequency or operating frequency range of the corresponding passive RFID tag; and/or a read range of the corresponding passive RFID tag, amongst other possible information. Any or all of this information may be useful for the purposes of training the machine learning algorithm.

A further operation 1106 comprises applying the machine learning algorithm to the training data to predict an occupancy state of the seat for each labelled set of normalised count values. Operation 1108 then comprises comparing, for each labelled set of normalised count values, the prediction of the machine learning algorithm with the label to determine if the machine learning algorithm's prediction was correct. Operation 1110 then includes adapting the machine learning algorithm (if necessary) to improve the accuracy of the machine learning algorithm. Operations 1106 to 1110 may be considered collectively to constitute the training of the machine learning algorithm and may be repeated as many times as necessary until the accuracy, precision, recall, and/or F-1 measure of the machine learning algorithm exceeds a predetermined required performance threshold. For example, the performance threshold may be 90% or more, 95% or more, 97% or more, 98% or more, 99% or more, or 99.5% or more.

### Activity Determination

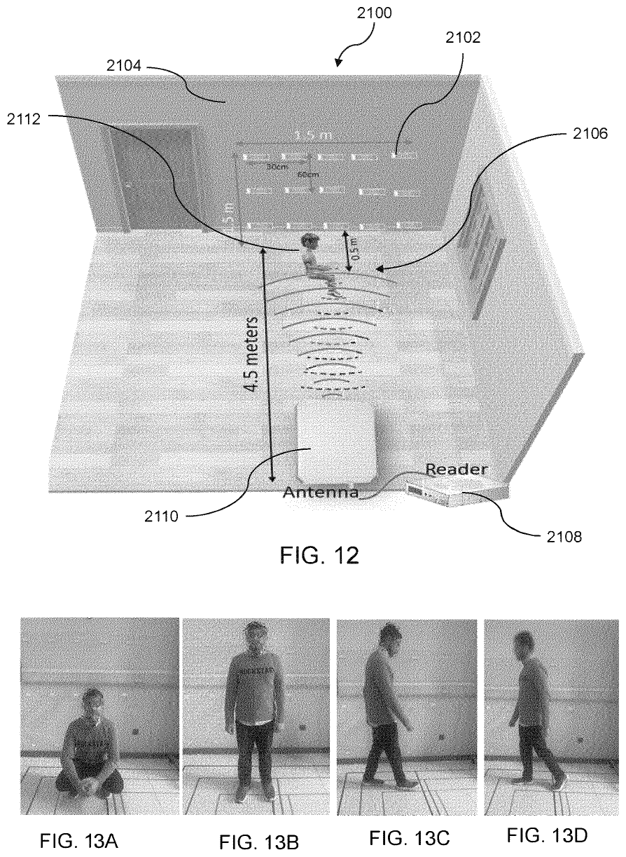

FIG. 12 shows an example of an RFID reader 2108 and an RFID antenna 2110 installed in an indoor environment 2100 for determining an activity being performed by a person 2112 in the environment 2100. A plurality of passive RFID tags 2102 are installed on a wall 2104 of the environment in a vertical array of passive RFID tags.

The RFID antenna 2110 is configured to broadcast an interrogation signal through a detection zone 2106 of the environment 2100 to the passive RFID tags 2102. The RFID reader 2108 is configured to receive one or more response signals from each of the passive RFID tags 2102 over a sample period (e.g., 3 seconds).

As can be seen in FIG. 12, the RFID reader 2102 and RFID antenna 2104 may be installed on an opposite side of the environment 2100 to the vertical array of RFID tags 2102 such that the interrogation signal is broadcast through the detection zone 2106. In this example, the RFID antenna 2110 is placed a horizontal stand-off distance of 4.5 metres from the array of passive RFID tags 2102. The RFID antenna 2110 is elevated above the ground and orientated towards the array of passive RFID tags, with a direct line of site towards the array of passive RFID tags 2102. In FIG. 1, the person 2112 is sitting in the detection zone 2106, 0.5m away from the RFID tags 2102, between the RFID tags 2102 and the RFID antenna 2110.

In this example, the vertical array of passive RFID tags 2102 comprises five columns and three rows of RFID tags 2102. The row are separated by a 60 cm vertical separation and the columns are separated by a 30 cm horizontal separation. Other arrangements and spacings of RFID tags 2102 may also be used. However, the present inventors found that this arrangement leads to particularly accurate determinations of what activities the person 2112 is performing in the detection zone 2106.

In use, a number of response signals received by the RFID reader 2108 from each passive RFID tag 2102 over a sample period is counted and compared to a control count value to determine a normalised count value. Next, the normalised count values are provided to a machine learning algorithm to determine the activity being performed in the detection zone 2106 of the environment 2100 during the sample period. This procedure can be repeated over a plurality of overlapping sample periods to provide continuous monitoring of the person's 2112 activities. As discussed below, in some examples, the machine learning algorithm is configured to receive sequences of normalised count values corresponding to multiple sample periods, and determine the person's 2112 activities based on the sequences of normalised count values.

The normalised count value may be determined by carrying out the following method. First, a number of response signals received from each passive RFID tag 2102 over a predetermined time period is counted. Second, this number of received response signals is compared with a control-count value—preferably by taking a ratio (i.e., dividing) of the number of received response signals and the control-count value. The control count value may be determined as the aggregated number of response signals received from the same passive RFID tag 2102 over a control time period, the control time period being a time period during which the environment is known to be unoccupied. This control time period is preferably a period of time equal in length to the sample period over which the response signals were received. In this way, the normalised count value for each collection run on a passive RFID tag can be considered to be normalised with respect to the performance of that same passive RFID tag during a time for which the environment is known to be unoccupied.

In some examples, the control count value may be an average of a series of previously determined control count values.

In some examples, the control count value may be a maximum count of response signals received during the control time period, wherein that control time period is one of a plurality of equal time periods in a user-set calibration phase of the passive RFID tag 2102. Typically, this maximum count is achieved in scenarios when the environment is empty.

By determining the control count value as described above, it is possible to remove any variations in the normalised count values that may arise due to different passive RFID tags being printed in different batches, or any effects arising from the age or quality of the passive RFID tags.

The methods described herein for determining the activities being performed in the environment are based on discriminating between the small differences in the normalised count values for activities.

FIGS. 13A to 13D show a person performing various activities in the detection zone of the environment, the activities shown being: sitting, standing, walking forwards, and walking backwards. The machine learning algorithm may be configured to determine which of these (or other) activities are being performed in the environment.

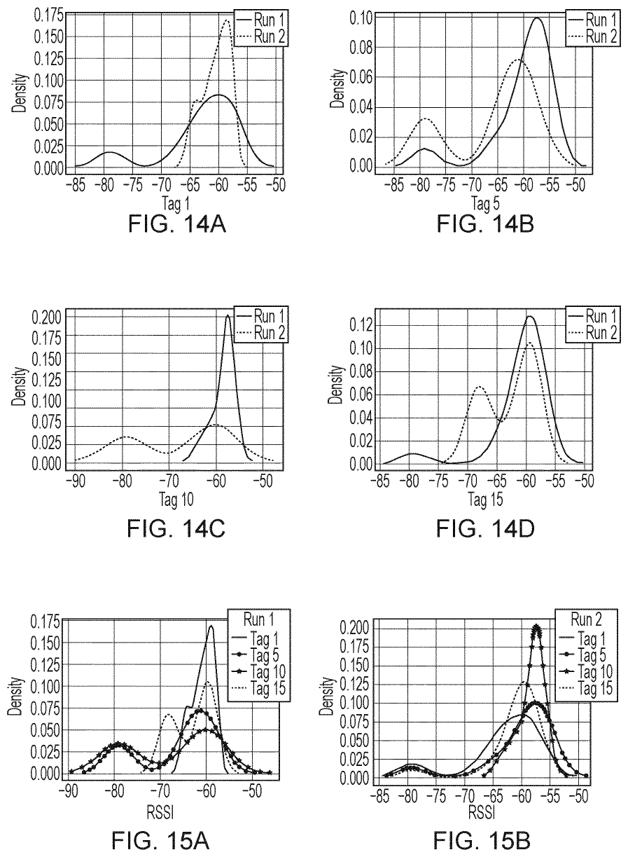

FIGS. 14A to 14D show probability density plots of RSSI values overtime for two different experimental runs where each plot shows results for a different RFID tag (Tag 1, Tag 5, Tag 10 and Tag 15). FIGS. 15A to 15B show probability density plots of RSSI values for the tags of FIGS. 14A to 14D on the same plot, where the plot of FIG. 15A shows the results for a first run and the plot of FIG. 15B shows the results for a second run.

RSSI is a traditional parameter of passive RFID tags which may be monitored. However, as shown in these plots, RSSI exhibits randomness and lack of determinacy between RFID tags and between runs using the same RFID tag. Therefore, it is clear from these plots that the inherent variation in RSSI is too random and inconsistent for making detailed activity predictions.

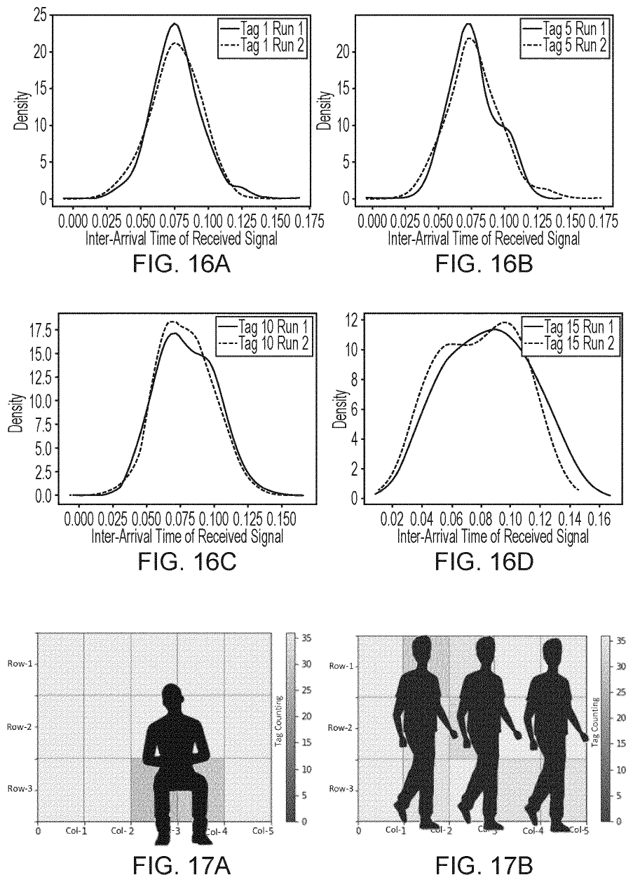

In contrast, FIGS. 16A to 16D show density plots for the inter-arrival times of received signals from the same RFID tags across several runs (i.e., the elapsed time between receiving a response signal from the RFID tag). As shown in these plots, the interarrival time (and hence frequency) between response signals received from the RFID tags is much more constant than the variation in RSSI parameters. Therefore, a count of response signals received over a sample period (i.e., “tag count”) from each RFID tag may instead be leveraged to determine activities being performed in the vicinity of the RFID tags.

FIGS. 17A to 17B show heat maps of the response signal count values from the plurality of passive RFID tags where each square of the heat map represents a passive RFID tag in the vertical array. To generate the heat map of FIG. 17A a person was sitting in the detection zone as shown, and for FIG. 17B, the person was walking through the detection zone. It is apparent from FIGS. 17A to 17B that when the person is located in front of a passive RFID tag for a period of time, a relatively lower count value is determined compared to when the person spends less or no time in front of that passive RFID tag (owing to the person's body partially disrupting the interrogation signal from reaching that RFID tag). This variation can be leveraged to determine the person's activity.

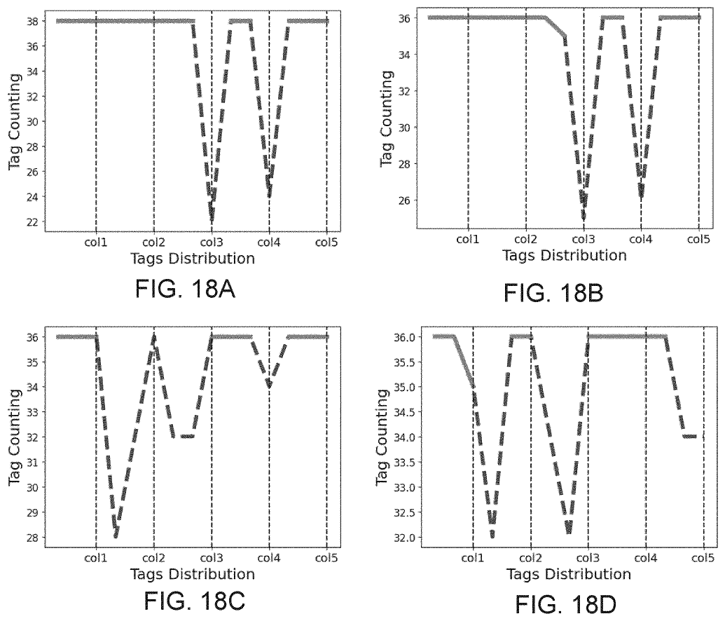

FIGS. 18A to 18D show distributions of total count values for passive RFID tags in columns 1 to 5 of the vertical array of RFID tags. The total count values were determined over a 3-second sample period. To generate the results of FIG. 18A a person was sitting in the detection zone of the environment in front of RFID columns 3 and 5. To generate the results of FIG. 18B the person was standing in the detection zone of the environment in front of RFID columns 3 and 5. To generate the results of FIG. 18C the person was walking forwards through the detection zone. To generate the results of FIG. 18D the person was walking backwards through the detection zone.

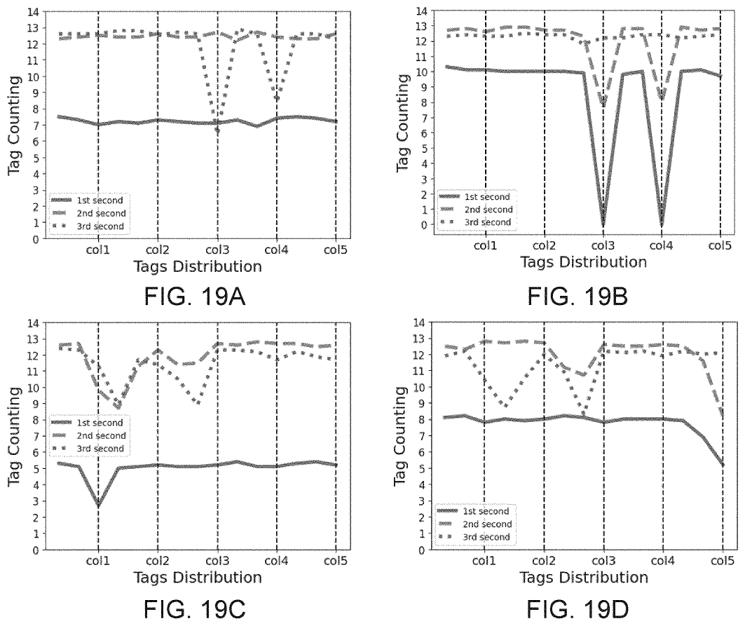

FIGS. 19A to 19D show distributions of the count value for each second of the sample period (i.e., a read rate per second) for the same RFID tags and activities as described above for FIGS. 18A to 18D respectively. As shown in these plots, the tag read rate changes from second to second as the person moves through the environment. Therefore, by monitoring the count value over a period of time (i.e., over a sample period or over multiple sample periods) more accurate predictions of the activity can be made.

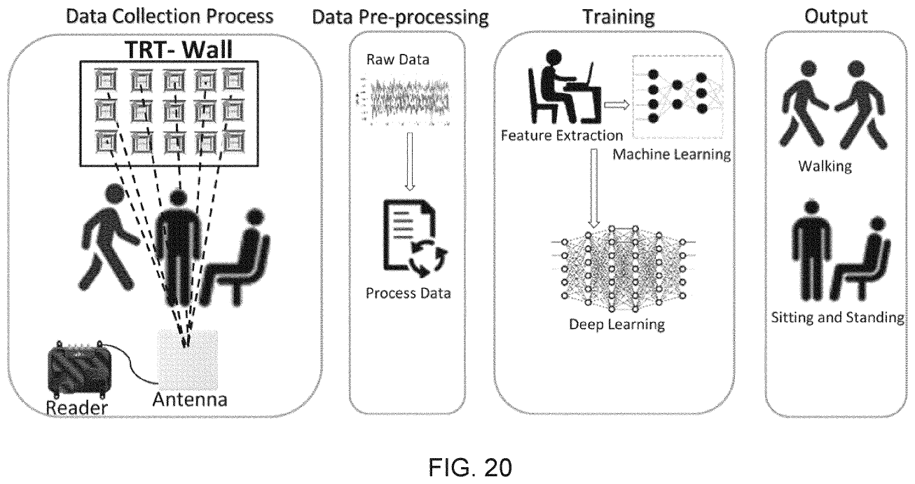

FIG. 20 shows a flow diagram of a method for collecting training data and using that training data to train the machine learning model for determining activities, for example in the environment shown in FIG. 12.

First, training data was collected by storing the response signals received from the array of passive RFID tags. The “raw data” for each response signal comprises RSSI and phase values for each signal from the RFID tag, as well as timestamps.

Next, the collected data is pre-processed to convert the received timestamps into count values for each 3-second sample period, the beginning of each sample period being separated by 1 second so that an updated count value is obtained every second. Next, the count values are normalised by comparing them to a control count value as discussed above to obtain sequences of normalised count values for each RFID tag.

The data collection and preprocessing steps are then repeated for different scenarios wherein a person or multiple people are performing various activities in the detection zone of the environment. A label corresponding to the activity being performed is associated with each set of data (each labelled set comprising a sequence of normalised count values for every passive RFID tag).

Next, the pre-processed and labelled data is used to train a machine learning model to determine activities being performed in the detection zone according to the method discussed below in relation to FIG. 23.

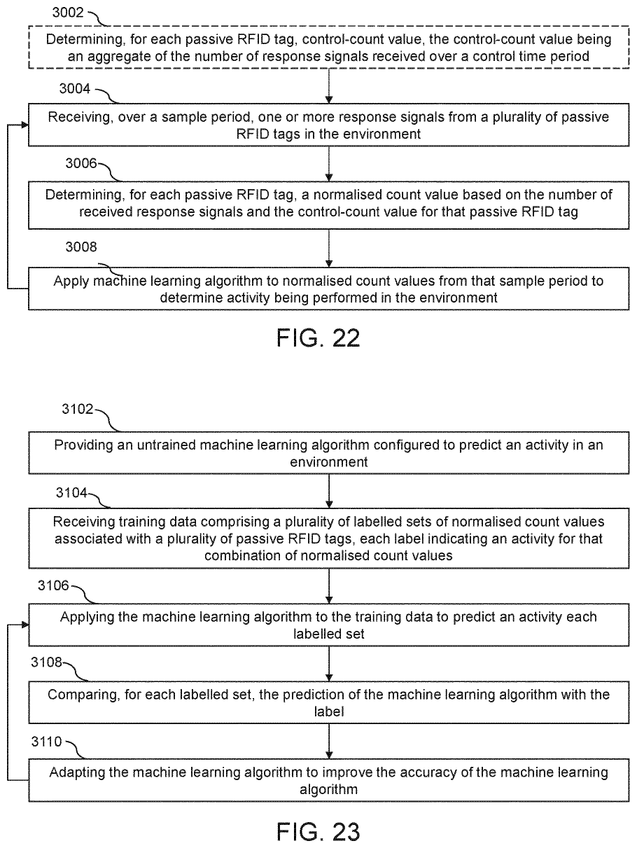

Finally, the trained machine learning model is deployed to make activity predictions based on new normalised count values received from the RFID array according to the method discussed below in relation to FIG. 22.

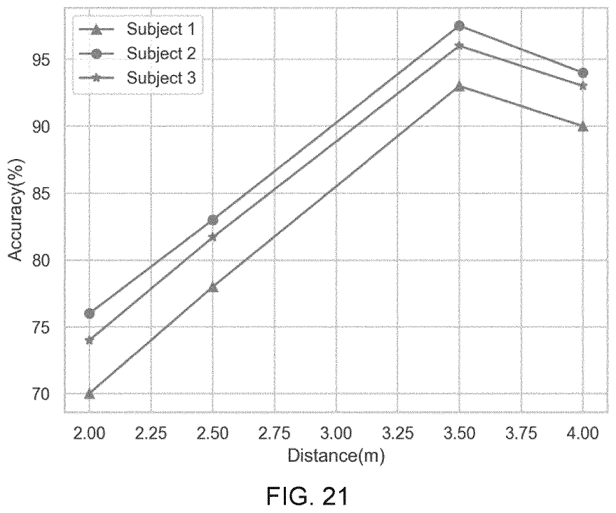

FIG. 21 shows a plot of model accuracy compared to a stand-off distance of the RFID antenna from the vertical array of RFID tags and for three different subjects (i.e., persons) in the detection zone using the set-up of FIG. 12. As shown in FIG. 21, the plot indicates that the accuracy of the machine learning model increased as the RFID antenna was moved further away from the RFID array, up until 3.5 m. It is believed that this distance enables a maximum number of the RFID tags to be utilised in the prediction without moving beyond a detection range of the RFID tags.

FIG. 22 shows a method for determining a person's activities in the environment. The method includes, in operation 3002, optionally determining for each passive RFID tag in the environment, a control count value as described above.

The method further includes, in operation 3004, receiving, over a predetermined time period, one or more response signals from one or more of the passive RFID tags located in the environment. These one or more response signals may be emitted by the passive RFID tags in response to receiving an interrogation signal from an RFID antenna installed in the environment, e.g., on the other side of a detection zone of the environment.

The method further includes, in operation 3006, determining for each passive RFID tag, a normalised count value based on the number of received response signals and the control-count value for that passive RFID tag. As discussed above, it is the small variations in the normalised count values that enable the determination of activities in the environment.

The method further includes, in operation 3008, applying a machine learning algorithm (such as an LSTM classifier as discussed below) to the normalised count values to determine an activity being performed in the environment (or if there is no activity being performed in the environment).

Finally, operations 3004 to 3008 are repeated over subsequent sample periods to generate continuous predictions of activities in the environment. For example, each sample period may be 3 seconds long wherein each sample period begins 1 second after the previous sample period began such that the sample periods overlap by 2 seconds and an activity is predicted every second.

The machine learning algorithm may be configured to receive time series data such as sequences of multiple normalised count values for each RFID tag which are measured over a plurality of overlapping sample periods. Therefore, the prediction may take account of a person's previous stance or location in a previous sample period for determining their current activity.

In some examples, when there are multiple people performing a same activity in the environment the machine learning algorithm is configured to localise each person and assign them a subject identifier. For example, in experiments performed by the present inventors, two subjects were engaged in the same activity in the environment. In these examples, the machine learning algorithm is configured to identify and differentiate both subjects and determine the activity being performed.

The table below shows the performance statistics for a variety of different machine learning algorithms applied to normalised count values to determine activities in an environment.

| Classifier | Accuracy (%) |
|---|---|
| LSTM (Long Short-Term Memory) | 97.75 |
| CNN (Convolutional Neural Network) | 94.0 |
| Hybrid LSTM + CNN | 93.0 |
| Linear Support Vector Machine (SVM) | 92.0 |
| DT (Decision Tree) | 88.0 |
| RF (Random Forest) | 88.0 |

The percentage accuracies are derived by comparing the model's predicted activities—and, optionally, associated subject identifiers—against known ground-truth activity data. Specifically, the percentage accuracy is calculated by determining the proportion of instances where the model's predictions align with the ground-truth labels.

The LSTM classifier referred to in the first row of the table above can be seen to be a particularly accurate algorithm for determining activities. The present inventors have found that LSTM classifiers are particularly suited to this activity for the following reasons:
1) Sequential Data: LSTM models excel at handling sequential data. The datasets used in the present experiments involved sequences of normalised count values (i.e., time series data) which LSTMs are particularly effective at handling.
2) Memory Cells: LSTM's memory cells can retain and reference older inputs. Therefore, in scenarios such as activity monitoring, where past data influences current outcomes, LSTM models are particularly effective for use as classifiers.
3) Avoidance of Vanishing Gradient: LSTMs counteract the vanishing gradient problem, which can impact traditional neural networks when training on long sequences.

FIG. 23 shows a method for training a machine learning algorithm to determine activities in an environment as discussed above. A first operation 3102 of the method for training includes providing an untrained machine learning algorithm (and preferably an LSTM as discussed above) that is configured to predict an activity being performed by a person in an environment based on sequences of normalised count values received from an array of passive RFID tags located in the environment in accordance with the method set out in relation to FIG. 22 above.

A further operation 3104 involves receiving training data that comprises a plurality of labelled sets of normalised count values associated with each passive RFID tag in the array. The label on each labelled set is indicative of an activity being performed in the environment for that normalised count value. For example, the label may identify if the normalised count value was determined when a person was: not present, standing, sitting, walking forward, walking backwards, or performing other activities in the environment. The training data may also comprise normalised count values collected when different quantities of subjects are performing the activity in the environment.

Each label may further comprise metadata indicative of one or more properties of each passive RFID tag corresponding to each normalised count value in the labelled set. These properties may include one or more of: a position of the RFID tag in the environment; a unique ID (e.g., manufacturer's batch ID) for the corresponding passive RFID tag; a date of manufacture of the corresponding RFID tag; a date on which each passive RFID tag was located in the environment; an operating frequency or operating frequency range of the corresponding passive RFID tag; and/or a read range of the corresponding passive RFID tag, amongst other possible information. Any or all of this information may be useful for the purposes of training the machine learning algorithm.

A further operation 3106 comprises applying the machine learning algorithm to the training data to predict an activity for each labelled set of (sequences of) normalised count values. Operation 3108 then comprises comparing, for each labelled set of normalised count values, the prediction of the machine learning algorithm with the label to determine if the machine learning algorithm's prediction was correct. Operation 3110 then includes adapting the machine learning algorithm (if necessary) to improve the accuracy of the machine learning algorithm. Operations 3106 to 3110 may be considered collectively to constitute the training of the machine learning algorithm and may be repeated as many times as necessary until the accuracy exceeds a predetermined required performance threshold. For example, the performance threshold may be 80% or more, 85% or more, 90% or more, or 94% or more.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example +/−10%.

1. A method for determining occupancy in a seating environment, the seating environment comprising a plurality of seats, each seat having a group of passive RFID tags attached thereto, wherein the method comprises:
receiving, over a predetermined time period, in response to an interrogation signal, one or more response signals from one or more of the passive RFID tags in the seating environment;
determining, for each passive RFID tag in the seating environment, a normalised count value based on a number of response signals received from said passive RFID tag over the predetermined time period; and
determining an occupancy state for each seat in the seating environment based on the determined normalised count values.

2. (canceled)

3. The method according to claim 1, wherein each group of passive RFID tags comprises at least three passive RFID tags spaced apart on a sear, and wherein the occupancy state for each seat is determined based on the determined normalised count values for the group of passive RFID tags attached to that seat.

4. The method according to claim 1, the method further comprising:
receiving, over a predetermined control time period, in response to an interrogation signal, one or more response signals from each passive RFID tag, wherein said passive RFID tag is attached to a seat that is unoccupied for a duration of the control time period; and
determining, for each passive RFID tag, a control-count value, the control-count value being an aggregate of the number of response signals received from said passive RFID tag over the control time period.

5. The method according to claim 4, wherein the determining, for each passive RFID tag, a normalised count value comprises: comparing the number of response signals received from said passive RFID tag over the predetermined time period with the control-count value for said passive RFID tag.

6-9. (canceled)

10. The method according to claim 1, wherein determining the occupancy state for each seat comprises: determining a type of occupancy for each seat determined to be occupied.

11. The method according to claim 1, wherein the determining an occupancy state for each seat comprises applying a machine learning algorithm configured to take the determined normalised count values as inputs, and determine, based on the determined normalised count values, an occupancy state for each seat in the seating environment, wherein the machine learning algorithm is an ensemble algorithm, comprising one or more of:
a support vector machine;
a ridge classifier;
a stochastic gradient descent algorithm; and/or
a multi-layer perceptron.

12-17. (canceled)

18. A networked system for determining occupancy in a seating environment comprising a plurality of seats, the system comprising:
a plurality of RFID tags attached to the seats, wherein each seat has a group of passive RFID tags attached thereto; and
a computing apparatus communicatively linked with the plurality of RFID tags, the computing apparatus being configured to:
receive, over a predetermined time period, in response to an interrogation signal, one or more response signals from one or more of the passive RFID tags in the seating environment;
determine, for each passive RFID tag in the seating environment, a normalised count value based on a number of response signals received from said passive RFID tag over the predetermined time period; and
determine an occupancy state for each seat in the seating environment based on the determined normalised count values.

19. The networked system according to claim 18, further comprising one or more RFID antennae configured to broadcast the interrogation signal throughout the seating environment; wherein the computing apparatus is part of a central server communicatively linked to the one or more RFID antennae over a 5G Internet of Things network, wherein the central server is communicatively linked with the plurality of RFID tags via the one or more RFID antennae.

20. (canceled)

21. A computer-readable medium comprising instructions that, when executed by a computing apparatus, causes the computing apparatus to carry out the method according to claim 1.

22. A method for determining an activity being performed by a person in an environment, the environment comprising a plurality of passive RFID tags, wherein the method comprises:
receiving, over a sample period, in response to an interrogation signal, one or more response signals from one or more of the passive RFID tags;
determining, for each passive RFID tag, a normalised count value based on a number of response signals received from said passive RFID tag over the sample period; and
using a machine learning algorithm to determine the activity being performed in the environment, the machine learning algorithm being configured to take the normalised count values as inputs, and determine, based on the normalised count values, the activity being performed in the environment during the sample period.

23. The method according to claim 22, wherein the environment further comprises an antenna, and wherein the method further comprises broadcasting the interrogation signal through the environment using the antenna, and configuring the antenna to receive the response signals from the plurality of passive RFID tags.

24. (canceled)

25. The method according to claim 23, wherein:
the environment comprises a detection zone,
the plurality of RFID tags are located on a first side of the detection zone, and
the antenna is located on a second side of the detection zone, such that the interrogation signal is broadcast through the detection zone and the machine learning algorithm is configured to determine an activity being performed in the detection zone of the environment.

26-27. (canceled)

28. The method according to claim 22, wherein the plurality of RFID tags are arranged in a planar array of passive RFID tags, wherein the planar array is a vertical array located on a wall of the environment, wherein the planar array is arranged in rows and columns to form a matrix, and wherein a horizontal separation between adjacent RFID tags in the matrix is between 15 cm and 50 cm, and a vertical separation between adjacent RFID tags in the matrix is between 40 cm and 80 cm.

29-30. (canceled)

31. The method according to claim 22 further comprising:
repeating a receiving and determining steps to determine normalised count values for one or more subsequent sample periods to provide a sequence of normalised count values for a plurality of sample periods, and
a machine learning model is configured to take the sequence of normalised count values as inputs and determine, based on the sequence of normalised count values, the activity being performed in the environment during each sample period.

32. (canceled)

33. The method according to claim 31, wherein a sample separation time between a start of each sample period and a start of each subsequent sample period is shorter than the sample periods.

34-35. (canceled)

36. The method according to claim 22, wherein the machine learning algorithm is configured to determine one or more of activities based on the normalised count values:
walking forwards,
walking backwards,
sitting, and
standing.

37. (canceled)

38. The method according to claim 22 further comprising:
receiving, over a predetermined control time period, in response to the interrogation signal, one or more response signals from each passive RFID tag, wherein there is no activity being performed in the environment for a duration of the control time period; and
determining, for each passive RFID tag, a control-count value, the control-count value being an aggregate of the number of response signals received from said passive RFID tag over the control time period.

39-45. (canceled)

46. A system for determining an activity being performed in an environment, the system comprising:
a plurality of passive RFID tags located in the environment; and
a computing apparatus communicatively linked with the plurality of RFID tags, the computing apparatus being configured to:
receive, over a sample period, in response to an interrogation signal, one or more response signals from one or more of the passive RFID tags;
determine, for each passive RFID tag, a normalised count value based on a number of response signals received from said passive RFID tag over the sample period; and
use a machine learning algorithm to determine the activity being performed in the environment, the machine learning algorithm being configured to take the normalised count values as inputs, and determine, based on the normalised count values, the activity being performed in the environment during the sample period.

47. The system according to claim 46 further comprises an antenna configured to broadcast the interrogation signal to the RFID tags through a detection zone of the environment.

48. A computer-readable medium comprising instructions that, when executed by a computing apparatus, causes the computing apparatus to carry out the method according to claim 22.
